(19) United States
(12) Patent Application Publication
(10) Pub. No.: US 2025/0371872 A1
(43) Pub. Date: Dec. 4, 2025

(54) BUILDING SECURITY SYSTEMS AND METHODS UTILIZING LANGUAGE-VISION ARTIFICIAL INTELLIGENCE TO IMPLEMENT A VIRTUAL AGENT

(71) Applicant: Tyco Fire & Security GmbH, Neuhausen am Rheinfall (CH)

(72) Inventors: Yohai Falik, Petah Tikva (IL); Rajkiran Kumar Gottumukkal, Bengaluru (IN); David Monahan, Belfast (GB)

(21) Appl. No.: 19/306,716

(22) Filed: Aug. 21, 2025

Related U.S. Application Data
(63) Continuation-in-part of application No. PCT/IB2024/058764, filed on Sep. 9, 2024.

(30) Foreign Application Priority Data
Sep. 8, 2023 (IN) 202321060416
Aug. 22, 2024 (IN) 202441063363
Aug. 23, 2024 (IN) 202441063594

(51) Int. Cl. G06V 20/40; G06V 20/52

(52) U.S. Cl. CPC G06V 20/41; G06V 20/44; G06V 20/52

(57) ABSTRACT

A building security system includes processors configured to: provide one or more machine learning models, at least one of the machine learning models trained to identify abnormalities within video data, the at least one machine learning model trained using at least one of video data or image data and annotations to the at least one of the video data or image data, and provide a virtual agent configured to: receive and process one or more input videos using the at least one machine learning model to identify abnormalities based on contextual information identified from the one or more input videos, and automatically perform, by the one or more machine learning models, an operator function in response to the identified abnormalities, wherein the operator function is determined according to at least one of a set of rules defined by the building security system or an operator input.

### CROSS-REFERENCE TO RELATED APPLICATIONS

This application claims the benefit of and priority to Indian Provisional Application No. 20/244,1063363, filed Aug. 22, 2024, and Indian Provisional Application No. 20/244,1063594, filed Aug. 23, 2024, and is a continuation-in-part of PCT Application No. PCT/IB2024/058764, filed Sep. 9, 2024, which claims the benefit of and priority to Indian Provisional Application No. 20/232,1060416, filed Sep. 8, 2023, each of which is incorporated herein by reference in its entirety and for all purposes.

### BACKGROUND

The present invention relates generally to building systems for buildings. This application relates more particularly, according to some example embodiments, to systems and methods for building security that use generative artificial intelligence.

### SUMMARY

One aspect relates to a building security system including: one or more computer-readable storage media having instructions stored thereon that, when executed by one or more processors, cause the one or more processors to: provide one or more machine learning models, at least one of the one or more machine learning models trained to identify abnormalities within video data, the at least one machine learning model trained using at least one of video data or image data and annotations to the at least one of the video data or image data, and provide a virtual agent configured to: receive one or more input videos and process the one or more input videos using the at least one machine learning model to identify one or more abnormalities based on contextual information identified from the one or more input videos, and automatically perform, by the one or more machine learning models, an operator function in response to the one or more abnormalities identified by the at least one machine learning model, wherein the operator function is determined according to at least one of a set of rules defined by the building security system or an operator input.

In some embodiments, the operator function includes generating an incident report. In some embodiments, the operator function includes retrieving video footage from the one or more input videos. In some embodiments, the operator function includes performing a risk analysis. In some embodiments, the operator function includes dispatching first responder support. In some embodiments, the operator function includes activating one or more alarms. In some embodiments, the image data further includes a series of static images. In some embodiments, the one or more machine learning models is a generative artificial intelligence (AI) model.

In some embodiments, the at least one machine learning model is trained by obtaining a foundation model and by tuning the foundation model using the annotations to the at least one of the video data or image data. In some embodiments, the at least one machine learning model is trained using enterprise-specific training data relating to an enterprise within which the building security system is implemented. In some embodiments, the enterprise-specific training data includes at least one of annotations to at least one of video data or image data corresponding to the enterprise, a set of rules defined by the enterprise, a plurality of incident reports associated with the enterprise, or a plurality of crime reports associated with the enterprise.

Another aspect relates to a method including: providing, by one or more processors, one or more machine learning models, at least one of the one or more machine learning models trained to identify abnormalities within video data, the at least one machine learning model trained using at least one of video data or image data and annotations to the at least one of the video data or image data, and providing, by the one or more processors, a virtual agent configured to: receive one or more input videos and process the one or more input videos using the at least one machine learning model to identify one or more abnormalities based on contextual information identified from the one or more input videos, and automatically perform, by the one or more machine learning models, an operator function in response to the one or more abnormalities identified by the at least one machine learning model, wherein the operator function is determined according to at least one of a set of rules defined by a building security system or an operator input.

In some embodiments, the operator function includes one or more of: generating an incident report, retrieving video footage from the one or more input videos, performing a risk analysis, or dispatching first responder support. In some embodiments, the operator function includes activating one or more alarms. In some embodiments, the image data further includes a series of static images. In some embodiments, the one or more machine learning models is a generative artificial intelligence (AI) model.

In some embodiments, the at least one machine learning model is trained by obtaining a foundation model and by tuning the foundation model using the annotations to the at least one of the video data or image data. In some embodiments, the at least one machine learning model is trained using enterprise-specific training data relating to an enterprise within which the building security system is implemented. In some embodiments, the enterprise-specific training data includes at least one of annotations to at least one of video data or image data corresponding to the enterprise, a set of rules defined by the enterprise, a plurality of incident reports associated with the enterprise, or a plurality of crime reports associated with the enterprise.

Another aspect relates to one or more non-transitory computer-readable media storing instructions thereon that, when executed by one or more processors, cause the one or more processors to perform operations including: providing one or more machine learning models, at least one of the one or more machine learning models trained to identify abnormalities within video data, the at least one machine learning model trained using at least one of video data or image data and annotations to the at least one of the video data or image data, and providing a virtual agent configured to: receive one or more input videos and process the one or more input videos using the at least one machine learning model to identify one or more abnormalities based on contextual information identified from the one or more input videos, and automatically perform, by the one or more machine learning models, an operator function in response to the one or more abnormalities identified by the at least one machine learning model, wherein the operator function is determined according to at least one of a set of rules defined by a building security system or an operator input.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for building security applications.

FIG. 2 is a block diagram of an example of a language model-based system for building security applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of implementing generative artificial intelligence architectures and validation processes for machine learning algorithms for building security systems.

FIG. 9A is a flow diagram of a method of using machine learning to generate text summaries of video footage from a security system.

FIG. 9B is a flow diagram of additional steps in the method of FIG. 9A.

FIG. 10 is a flow diagram of a method of using machine learning to automate a system response to an identified abnormality in video footage of a security system.

FIG. 11 is a flow diagram of a method of using machine learning to process audio data from video footage of a security system.

FIG. 12 is a flow diagram of a method of using machine learning to track entities within an environment based upon digital representations of the entities.

FIG. 13 is a flow diagram of a method of using machine learning to supervise a delivery to a facility.

FIG. 14 is a flow diagram of a method of generating text summaries from video footage, according to an exemplary embodiment.

FIG. 15 is a perspective view schematic drawing of a building with a security system, according to some embodiments.

FIG. 16 is a block diagram of building security systems for multiple buildings communicating with a cloud-based security system, according to some embodiments.

FIG. 17 is a block diagram illustrating several components of an access control system (ACS) that can be implemented in the building security systems of FIG. 16, according to some embodiments.

FIG. 18 is a block diagram of a security system including a machine learning model trained to recognize objects and events in video data, according to some embodiments.

FIG. 19 illustrates a process for using the system of FIG. 18 to perform an operator function, according to some embodiments.

FIG. 20 illustrates a process for using the system of FIG. 18 to perform an operator function within a specific enterprise, according to some embodiments.

FIG. 21 illustrates a flowchart of a process for providing a chatbot in a building security system, according to some embodiments.

FIG. 22 illustrates a flowchart of a process for providing a virtual agent in a building security system, according to some embodiments.

FIG. 23 illustrates an example of a security operations center (SOC) of a building security system, according to some embodiments.

FIG. 24 illustrates an example of a text summary of a surveillance video generated by the model of FIG. 18, according to some embodiments.

FIG. 25 illustrates an example of an incident report generated by the model of FIG. 18, according to some embodiments.

FIG. 26 illustrates an example of statistics derived from video data by the model of FIG. 18, according to some embodiments.

FIG. 27 illustrates an example of annotated video data and/or image data used to detect anomalous activity using the model of FIG. 18, according to some embodiments.

FIG. 28 illustrates an example of a static image used in risk scoring using the model of FIG. 18, according to some embodiments.

FIG. 29 illustrates an example of a user interface which can be used to receive a query and provide a video and/or image in response, according to some embodiments.

FIG. 30 illustrates an expanded view of one of the video search results shown in FIG. 29, according to some embodiments.

FIG. 31 illustrates an example of video data used to train the model of FIG. 18, according to some embodiments. This example may be used to illustrate the use of audio data to help detect abnormal behavior (e.g., violence, in this example).

FIG. 32 illustrates another view of the video data presented in FIG. 31, according to some embodiments. This example may be used to illustrate the use of audio data to help detect abnormal behavior (e.g., violence, in this example).

### DETAILED DESCRIPTION

Referring generally to the FIGURES, systems and methods in accordance with the present disclosure can implement various features to precisely generate data relating to operations to be performed for managing building security. For example, various systems described herein can be implemented to more precisely generate data for various applications including, for example and without limitation, detecting anomalies amid building activity; generating text summaries of video footage for various building personnel; evaluating risk levels of detected events and sending notifications in response to the identified risk; and/or automating appropriate responses to the risk assessment and anomaly detection, including triggering first responder support. Various such applications can facilitate both asynchronous and real-time security operations, including by generating text data for such applications based on data from disparate data sources that may not have predefined database associations amongst the data sources, yet may be relevant at specific steps or points in time during security operations.

According to example embodiments, some systems and methods described herein utilizing machine learning, such as generative artificial intelligence (AI) and/or other types of AI models, in building management and/or monitoring. In some embodiments, the systems and methods utilize generative AI models and/or other types of machine learning models for analyzing and taking actions on image and/or video data, such as data captured from cameras within or near a building. Various example implementations are described below. In some implementations, the embodiments described herein and/or other types of embodiments could be implemented using systems and methods similar to those described in U.S. Provisional Patent Application No. 63/466,203, filed May 12, 2023, and/or Indian Patent Application number 202321051518, filed Aug. 1, 2023, both of which are incorporated herein by reference in their entireties.

In some embodiments, security operations can be supported by text information, such as predefined text documents (e.g., suspicious activity and/or emergency evacuation guides). Such predefined text information may not be useful for specific security threats and/or personnel responding to the event. For example, the text information may correspond to emergency situations or suspicious activity to be addressed. The text information, being predefined, may not account for specific security issues that may be present in the detected anomalies of building operation.

AI and/or machine learning (ML) systems, including but not limited to LLMs or other generative AI models (e.g., generative transformer models, such as generative pretrained transformers, generative adversarial networks (GANs), etc.) and/or non-generative AI models (e.g., neural networks, such as deep neural networks), can be used to generate text data and data of other modalities in a responsive manner to real-time conditions, including generating strings of text data and/or other data that may not be provided in the same manner in existing documents, yet may still meet criteria for useful information, such as relevance, style, and coherence. For example, LLMs can predict text data based at least on inputted prompts and by being configured (e.g., trained, modified, updated, fine-tuned) according to training data representative of the text data to predict or otherwise generate.

In some embodiments, various considerations may limit the ability of such systems to precisely generate appropriate data for specific conditions. For example, due to the predictive nature of the generated data, some LLMs may generate output data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data. In some instances, relatively large LLMs, such as LLMs having billions or trillions of parameters, may be less agile in responding to novel queries or applications. In addition, various LLMs may lack transparency, such as to be unable to provide to a user a conceptual/semantic-level explanation of why a given output was generated and/or selected relative to other possible outputs.

Systems and methods in accordance with the present disclosure can use machine learning models, including LLMs and other generative AI systems, to capture data, including but not limited to unstructured knowledge from various data sources, and process the data to accurately generate outputs, such as security operations responsive to detected anomalies, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as security personnel, through relevant security operations responses.

This can include, for example, receiving data from security operation reports in various formats, including various modalities and/or multi-modal formats (e.g., text, speech, audio, image, and/or video). The system can facilitate automated, flexible user report generation, such as by processing information received from security personnel and other users into a standardized format, which can reduce the constraints on how the user submits data while improving resulting reports. The system can couple unstructured security data to other input/output data sources and analytics, such as to relate unstructured data with outputs of timeseries data from building operations (e.g., sensor data; report logs) and/or outputs from models or algorithms of building operation, which can facilitate more accurate analytics, security services, threat prevention, and/or anomaly detection.

For example, the system can provide a platform for anomaly detection and security operations in which a machine learning model is configured based on connecting or relating unstructured data and/or semantic data, such as human feedback and written/spoken reports, alone or in combination with sensor data such as camera data, with time-series product data regarding building operations, so that the machine learning model can more accurately detect causes of alarms or other events that may trigger security responses. For instance, responsive to sudden crowd gathering, the system can more accurately detect a cause of the gathering, and generate a recommendation (e.g., for a security officer) for responding to the gathering; the system can request feedback from the security officer regarding the prescription, such as whether the prescription correctly identified the cause of the gathering and/or actions to perform to respond to the cause, as well as the information that the security officer used to evaluate the correctness or accuracy of the prescription; and/or the system can use this feedback to modify the machine learning models, which can increase the accuracy of the machine learning models.

In some embodiments, a user can interact with the system using a chat-based interaction. A search within the system can be initiated by voice prompt or talking with the system about what data a user is looking for. The output from the system can be voice based, which can prove useful in a mobile NVR system, robots, etc. By chatting with the system, a user can be more specific about the event they are interested in and the relevant data. For example, if a user searches for “person with red dress,” they can specify “man with red dress” from the generated results. A user can interact with VMS using chat and NLP. For example, the user can say “show me a view of all cameras covering our parking lot,” and from there, the user can save a video from Camera No. 10 over the past hour to retrieve the footage relevant to the specific event they are interested in analyzing.

In some instances, significant computational resources (or human user resources) can be required to process data relating to security operation, such as time-series building data and/or sensor data, to detect or predict anomalies and/or causes of anomalies. In addition, it can be resource-intensive to label such data with identifiers of anomalies or causes of anomalies, which can make it difficult to generate machine learning training data from such data. Systems and methods in accordance with the present disclosure can leverage the efficiency of language models (e.g., GPT-based models or other pre-trained LLMs), and/or multi-modal models such as those that cross-correlate images and/or video and text, in extracting semantic information (e.g., semantic information identifying anomalies, causes of anomalies, and other accurate expert knowledge regarding building security) from the unstructured data in order to use both the unstructured data and the data relating to building security to generate more accurate outputs regarding building security. As such, by implementing language models using various operations and processes described herein, building management and security operation systems can take advantage of the causal/semantic associations between the unstructured data and the data relating to building security, and the language models can allow these systems to more efficiently extract these relationships in order to more accurately predict targeted, useful information for security applications at inference-time/runtime. While various implementations are described as being implemented using generative AI models such as transformers, GANs, and/or multi-modal models such as the CLIP (Contrastive Language-Image Pretraining) model, in some embodiments, various features described herein can be implemented using non-generative AI models or even without using AI/machine learning, and all such modifications fall within the scope of the present disclosure.

The system can enable a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for evaluating or addressing the anomaly to identify information that the system can use to detect root causes or other issues. The system can use the interface to present information regarding actions to perform in response to the anomaly, as well as instructions for how to perform the actions in response to the anomaly.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or security configuration model.

The system can be used to automate interventions for building operation, security services, anomaly detection, and alerting operations. For example, by being configured to perform operations such as anomaly detection, the system can monitor data regarding building operations to predict events associated with anomalies and trigger responses such as alerts, evacuation processes, and first responder support to address the anomaly. The system can present to a security officer or manager of the facility a report regarding the intervention (e.g., action taken responsive to detecting an anomaly) and requesting feedback regarding the accuracy of the intervention, which can be used to update the machine learning models to more accurately generate interventions.

### I. Machine Learning Models for Building Management and Security Operations

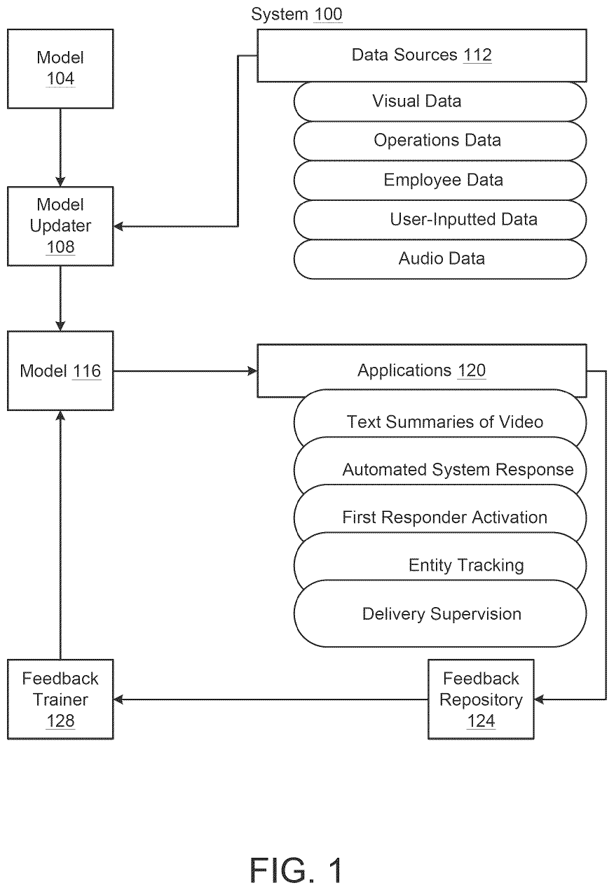

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building security operations.

For example, the system 100 can be implemented for operations associated with video footage from facility cameras. The system 100 can translate video footage to text and create a library of text covering given periods of time, for example, a day. With the library of day—of texts, the system can perform text-to-text comparisons day over day (or between any specified periods) for the purpose of anomaly detection. A foundation model can be generated based on the data, and a large language model (LLM) can be generated to describe the pattern. In some embodiments, the systems and methods of the present disclosure can utilize models, including but not limited to the anomaly detection model, that can be or include a multi-modal model that is trained on, takes as input, and/or outputs data based on two or more different modalities of data (e.g., both image/video data and text data). For example, in some embodiments, the model may be, include, or be similar to a CLIP (Contrastive Language-Image Pretraining) model, such as a CLIP4Clip model that extracts features and/or textual/description content from image and/or video input, such as video footage from cameras of a building. CLIP4clip models can analyze video footage and summarize it using text and/or feature extraction. In order to train the anomaly detection model to generate a sufficient description of the video, the foundation model can be used to describe texture on the video and to create features of embedding. The foundation model can then be used to create (e.g., train) another model using the output of the foundation model. According to some implementations, the present disclosure combines the foundation model with anomaly detection so that improved video descriptions using the foundation model can simplify training the anomaly detector and/or other types of models described herein.

In some embodiments, the system 100 can implement or utilize a multi-modal model that ingests video and outputs audio and/or ingests audio and outputs other modalities such as video or text, such as a CLIP to audio framework. In such a model, a neural network can include audio, video, and natural language processing (NLP) captions. This network will enable the model to understand audio events as well, whereas the original CLIP model only combines text and images. This model is useful in using unique sounds, such as the sound of a gun shot or aggressive behavior, to detect anomalies, for example. The concept can also be implemented in reverse using live annunciations. That is, a scene may be described to a user based on what is occurring (serving a similar purpose to subtitles on a video) rather than by typing the question into the system. In some implementations, alerts can be generated based on what a user's preidentified “watch items” may be. Example use cases of such implementations include a visually impaired user and/or process environment/control rooms.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as documents (e.g., security guides) that include both text and image/video information.

In some implementations, the first model 104 can include a multi-modal model configured to ingest data in one or more first modalities and output data in one or more second modalities. For example, in some implementations, the first model 104 can be or include a multi-modal model configured to ingest video and/or image data and output text of the video (e.g., text describing what appears in the video, textual context describing the video, etc.) and/or features of the video (feature embeddings, such as image feature extractions). In some implementations, the first model 104 may be trained using pairs of images and textual descriptions. In some implementations, the first model 104 may receive as input an image or video and may output a predicted textual description or feature extraction the first model 104 predicts to most closely correspond to the input data. In some implementations, the first model 104 may receive as input a textual description and output an image, set of images, video, etc. the first model 104 predicts to most closely correspond to the textual description. In some implementations, the first model 104 may be or include a CLIP or CLIP4Clip model. In some implementations, the first model 104 may additionally or alternatively be trained on, receive as input, and/or generate as output audio information, directly and/or by ingesting and/or generating textual data that is converted to audio or vice versa.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a security operation or one or more portions of a security operation, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to building security systems. For example, the training data can include video footage or images from facility cameras, operations data, employee-related data, user-inputted data, and audio data. In some implementations, the video footage and/or images may be paired with corresponding textual descriptions of the images/videos, such that the training data includes image/text pairs. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) diffusion models, and/or multi-modal models such as image-text models (e.g., models described above, such as CLIP and CLIP4Clip). The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of assets or building management systems or portions thereof), data lakes, data repositories, documentation records, or various combinations thereof. In some implementations, the data sources 112 include security camera data in any of text, speech, audio, image, or video data, or various combinations thereof, such as data associated with detected anomalies including but not limited to crowd gatherings, crowd dispersion, unknown employees, misplaced assets, and/or threatening behavior. Various data described below with reference to data sources 112 may be provided in the same or different data elements, and may be updated at various points. The data sources 112 can include or be coupled with security operations (e.g., where the security operations output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which security operations are engaged to detect relationships between various different data relating to the security operation (e.g., to train the models 104, 116 using both timeseries data (e.g., sensor data; outputs of algorithms or models, etc.) regarding a given security operation and freeform natural language reports regarding the given security operation).

The data sources 112 can include an audio data source 112. For example, an audio data source 112 can include a live audio stream (e.g., to a phone or a radio) that can allow building security to monitor a site more effectively when minimal security staff is present (e.g., overnight). The live audio stream can describe any activity (e.g., identifying a delivery lorry at the building gate or an individual recognized in a secure area). The description can flag an event that should disturb the security. The security radio can be interrupted automatically to alert security of the scene and summarize the events seen by the cameras. This live audio description offers a more consistent security system, especially when the security operations center (SOC) may be left empty and can reduce the amount of security staff required on site.

The data sources 112 can include unstructured data or structured data (e.g., data that is labeled with or assigned to one or more predetermined fields or identifiers, or is in a predetermined format, such as a database or tabular format). The unstructured data can include one or more data elements that are not in a predetermined format (e.g., are not assigned to fields, or labeled with or assigned with identifiers, that are indicative of a characteristic of the one or more data elements). The data sources 112 can include semi-structured data, such as data assigned to one or more fields that may not specify at least some characteristics of the data, such as data represented in a report having one or more fields to which freeform data is assigned (e.g., a report having a field labeled “describe the security operation” in which text or user input describing the security operation is provided).

For example, using the first model 104 and/or second model 116 to process the data can allow the system 100 to extract useful information from data in a variety of formats, including unstructured/freeform formats, which can allow security personnel to input information in less burdensome formats. The data can be of any of a plurality of formats (e.g., text, speech, audio, image, video, etc.), including multi-modal formats. For example, the data may be received from security personnel in forms such as text (e.g., laptop/desktop or mobile application text entry), audio, and/or video (e.g., dictating findings while capturing video).

In some embodiments, a bank of prompt questions relevant to a particular location can be created to more effectively retrieve relevant images in the data sources 112. For example, bank prompt questions can vary from business building prompt questions, and so forth. CLIP can be used to create a daily transcript that is helped using proper prompt questions. For example, in a mall, a proper prompt question may be “Is there a boy alone by the escalator?” The prompt questions should be written with the objective of receiving the best response for retrieving relevant footage of the event.

The system 100 can include, with the data of the data sources 112, labels to facilitate cross-reference between items of data that may relate to common security operations, sites, security personnel, users, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as security reports) at the same time or near in time.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., actions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or more parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the visual data source 112 for the first responder activation application 120, or select various combinations of data from the data sources 112 (e.g., visual data, operations data, and audio data) for the first responder activation application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the detected anomaly, a duration of the detected anomaly, a risk assessment of the detected anomaly, a site at which the anomaly is detected, or a history of anomalies at the site, to condition the training of the second model 116. For example, the system 100 can combine (e.g., concatenate) various such classifiers with the data for inputting to the second model 116 during training, for at least a subset of the data used to configure the second model 116, which can enable the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include user interfaces, dashboards, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a security officer, and generate reports in a standardized format, such as a user-specific format. This can allow, for example, security personnel to automatically, and flexibly, generate user-ready reports after security events without requiring strict input by the security officer or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one text summary application configured to generate text summaries of video footage for users. In some such implementations, the text summary application may generate text summaries depending on one or more of a variety of different factors, such as a user/recipient's role, position, and/or responsibilities (e.g., Executive-, Director-, and Operator-level details). For example, the text summary application may generate, based on a particular video input or set of video inputs, a first summary for an executive-level user and a different second summary for an operator-level user. In various implementations, the summaries may differ based on the type of content, the amount of content, a timeframe to which the summary corresponds, a frequency of generating the summary (e.g., more frequent summaries for a lower-level role), etc. While role is one example factor for determining the text summaries, the summaries could be generated based in part on a variety of other factors, including, but not limited to, location, individuals present at the location, events (e.g., events occurring at the location), and/or various other factors. In some embodiments, the text summary application may output a short summary of one or more input videos and/or images. In some embodiments, a foundation model or other type of model can be used to combine a plurality of summaries (e.g., many small summaries). In some embodiments, the video can be analyzed with object detection or motion detection to omit irrelevant or motionless video footage from being sent to the model (e.g., using a smart camera with an AI model to run the analysis). In various embodiments, a variety of different factors and/or image processing techniques may be utilized to determine portions of input videos/images that are more or less relevant than other portions, and “relevance” may differ depending on the intended use case (e.g., movement may be most relevant for one use case but not for another use case). In some embodiments, the system can use a push model to send push notifications with the summaries through SMS, email, app notifications, and/or some other method. The summaries can also be sent at different frequencies depending on the user (e.g., user role, user preferences, etc.).

In some implementations, the text summary application can include any user-specified duration of video footage. When the user initiates a query to receive the summary, they may define a window of time for the summary to cover. An LLM or other type of machine learning or AI model can be used to combine text description outputs from multiple videos into a narrative summary. The LLM can create context that can be fed into a bank of queries from the users and/or into a CLIP query. Additionally, or alternatively, textual output from a multi-modal model such as CLIP can be fed into an LLM configured to generate a combined narrative summary from the output. In various examples, the model may perform basic concatenation of the individual textual descriptions to form the full description or may perform more complex processing, such as generating a unique, new textual description of multiple video and/or image inputs. The results from the LLM can be grouped over a window of time, and the text descriptions from the group can be used to create the narrative summary received by the user. For example, if a user requests a day summary for a particular worker or other individual on the site, the narrative may include time and/or other circumstances of the worker's arrival to site, time spent on site, time seen actively working versus taking breaks, any unusual actions or activities outside the norm of what would be expected for the worker's role, time of departure from site, etc. According to some embodiments, the present disclosure creates unique use cases of the summaries of videos by weaving them together into a more useful deliverable to the user.

The text summary application can be used in summary-to-summary comparisons, such as to generate risk scores, in some example implementations. Interaction between the user and the system, such as receiving user feedback, can collect the user's evaluation of the level of risk for certain activities. A risk notification can be sent to a user based on the video to text analysis. Context from the video (for example, was an employee in the building alone, was there detection of a fire, was there an indoor air quality alert, etc.) can be provided in order to identify one or more users to receive the notification; for example, one context may cause the system to generate an alert for a single user designated to address a particular issue associated with the context, and another context may cause the system to send alerts to multiple users, such as a security officer and a facility manager and/or a person to whom there may be a risk in view of the context, either as simultaneous alerts, cascading alerts (e.g., such that an alert is sent to a second recipient if a first recipient does not acknowledge an alert or take action in a particular timeframe), or in some other manner. An alert can activate another specific model, such as wide area tracking or re-identification. For example, if the video analysis detects a child alone in the building, the associated alert can activate a wide area tracking model to know where to send security. This risk scoring process can automatically assess the risk level from the text description of the videos and determine whether immediate action is required based on that assessment. In some implementations, the models may generate actual scores evaluating a severity and/or location impact of the risk event, such as a numerical score or other relative risk score.

In some embodiments, the text summary application can be used to automatically create an incident storyboard by combining the text summary with significant images (e.g., persons of interest, damages, etc.). A security team can create an incident report including still image capture, original video clips, and textual summaries describing what happened, but an automatically created incident storyboard may be more efficient when responding to an anomaly (e.g., by automatically generating relevant context as opposed to leaving it to the security team to glean the context from the raw data). In some example implementations, this storyboard can be automatically sent to users who may have additional information to fill in (for example, identifying names).

In some implementations, the applications 120 can include at least one automated system response application (e.g., calling the police and/or fire services dispatch or turning on a fire alarm and/or security alert system). Receiving a textual summary of the event or an alarm can trigger an automated system response application 120 based on what is identified in the text. The response can vary automatically based on different contexts, in some implementations. The system may be used to trigger a sequence of operations (e.g., a life safety process, propping and/or unlocking doors, etc.) and can depend on whether an individual identified in the video is a known individual/employee or an unknown individual. The automation path that is triggered may differ depending on the results of the video analysis. For example, the automation may differ based on a type of event revealed by the video (e.g., fire, intruder, fight or other security event, active shooter, unauthorized entry, etc.). In some examples, the automation may differ based on a context of the video; for example, if the context indicates a user is attempting to escape an active shooter, the automation may unlock or automatically open a door to allow the user to escape, where if the context indicates the individual is the active shooter, the automation may shut and/or lock doors to trap the shooter in a confined space. The action to be taken can be automated based on the natural language processing (NLP) summary of the video.

For example, one automated action may include announcing a fire in the building using a public service announcement (PSA) throughout the building. In order to implement the automation component in a building, processes similar to those used in a supervisory control and data acquisition (SCADA) architecture can be used to respond to live events happening across a facility. For example, system outputs such as light levels or process flow can be altered and signage can be controlled to assist with directing the response to an emergency. Integration into facility systems such as elevators, building controllers, signage, lighting, water controls, power usage, network management (to enable or disable Ethernet ports), etc., can be used to trigger the automated system response application after detecting an anomaly and assessing the risk.

In some implementations, the applications 120 can include at least one first responder activation application, for example, based on situational awareness. Live or non-live notifications associated with anomalous scenes can be provided for first responder support based on situational awareness. For example, paramedic support may be provided in response to a crowd gathering around an injured individual, police or tactical support may be provided in response to a sudden crowd dispersion due to an individual revealing a weapon, firefighters may be deployed in response to crowd dispersion due to an accident involving a fire, etc.

In some cases, first responder support may be provided for general flow management as a preventative action when large crowds suddenly gather in areas due to events such as school outings or road closures, for example. When live statistics of approximate people counts in key areas indicate an abnormal event, integration of an autonomous response system into textual and/or audio systems for public annunciations, signage, lighting, and barrier control may be provided. This integration layer can link together automation, video, access control, building management, and fire assessment systems, for example, such as to provided support when a staged evacuation is triggered. The autonomous live monitoring can show changes in statistics of people and vehicle (live and historic) flow with sub-system displays. The foundation model can review scenes to deliver a higher-level command and control solution (end-to-end). In some cases, outside companies may generate reports from social media to a facility's security center that can also be used in risk evaluation and response automation. In an area with large crowds, when a normal situation becomes an anomaly, the system may serve to narrow down the most important aspects of the situation and identify where the security staff should focus their response.

In some implementations, the applications 120 can include at least one entity tracking application. An anomaly detection can be instantiated by a digital twin entity of an event or of a set of assets, in some implementations. Data contained in the digital twin can be matched with characteristics from video footage spanning multiple cameras to detect anomalies. A narrative story of that digital twin can be created. Compliance and current state data that is stored in the digital twin can be used to identify changes that should not have taken place. These changes can be flagged as an anomaly. For example, when camera footage reveals hospital equipment that is not in its correct position as indicated by the digital twin entity, this may be flagged as an anomaly. While a digital twin is specifically discussed here, it should be understood that the video data and/or text summaries and/or feature extractions of the video data can additionally or alternatively be compared to data from any other type of data source, and is not limited to digital twins.

The entity tracking application can also be used to produce reports detailing the handling of stock. For example, when dealing with perishable stock, the time that it is not in its proper storage environment needs to be controlled/minimized. In order to do so, the perishable stock can be identified and monitored, raising alerts if the stock is not placed in its proper storage environment within an appropriate time. The entity tracking application 120 can also generate handling reports for deliveries related to perishable stock. An AI model can also be trained to identify a range of stock mishandling events (e.g. if the stock is dropped, knocked/rammed, maliciously damaged, or if new stock is placed in front of old). The entity tracking application 120 can then create review actions and reports.

In some implementations, the applications 120 can include a delivery supervision application 120. Deliveries can arrive at a facility any time of the day or night, so multiple AI/visual intelligence functions can be employed to monitor these around-the-clock deliveries. For example, license plate recognition (LPR) can initially recognize the delivery. Then, facial recognize can verify the driver. An interactive voice can direct the driver to the assigned loading bay. The system can open and close the gate and monitor for tailgaters. The truck can be monitored from the gate as it travels to its assigned loading bay, the system reporting any abnormalities to a remote SOC. The system can then open and light the assigned loading bay. The load can be monitored, noting the characteristics of the delivery (e.g., four pallets left), and any abnormalities or safety issues (e.g., the driver fell) can be reported. The truck's departure can be monitored from the assigned loading bay back to the gate. The gate can be opened and closed. The assigned loading bay can be closed upon the truck's departure. A delivery report is then generated and sent to the appropriate team. A similar series of functions can also be applied to collections, with the interactive voice assigning the stock for collection rather than the loading bay.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs.

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

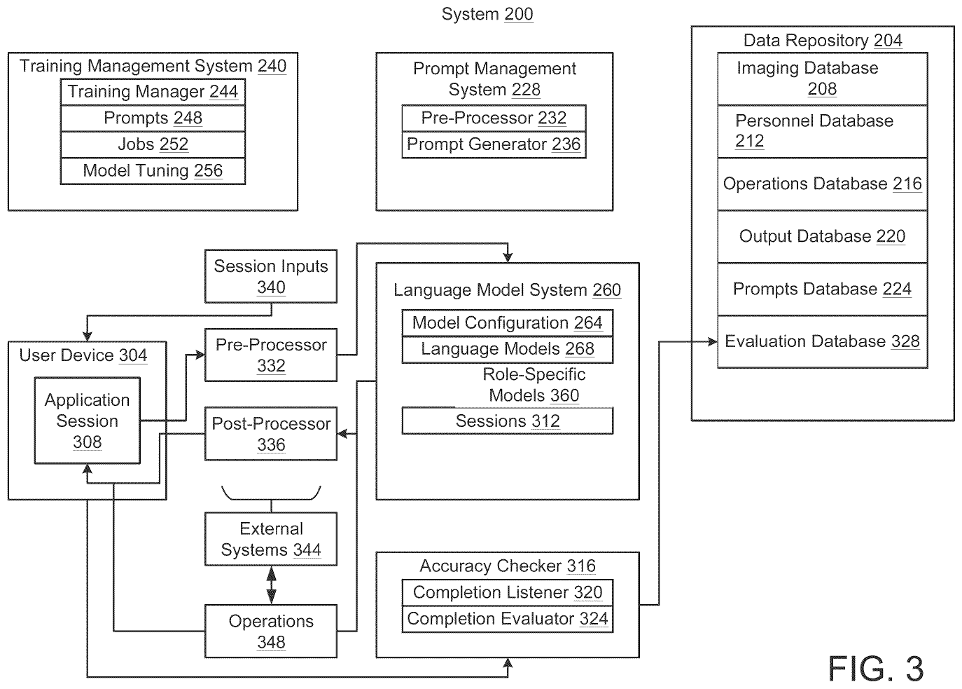

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to security operations, such as alarm usage models, entity tracking models, facility population models, or air quality models. For example, the second model 116 can be used to process unstructured information regarding security operations into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### II. System Architectures for Generative AI Applications for Building Management System and Security Operations

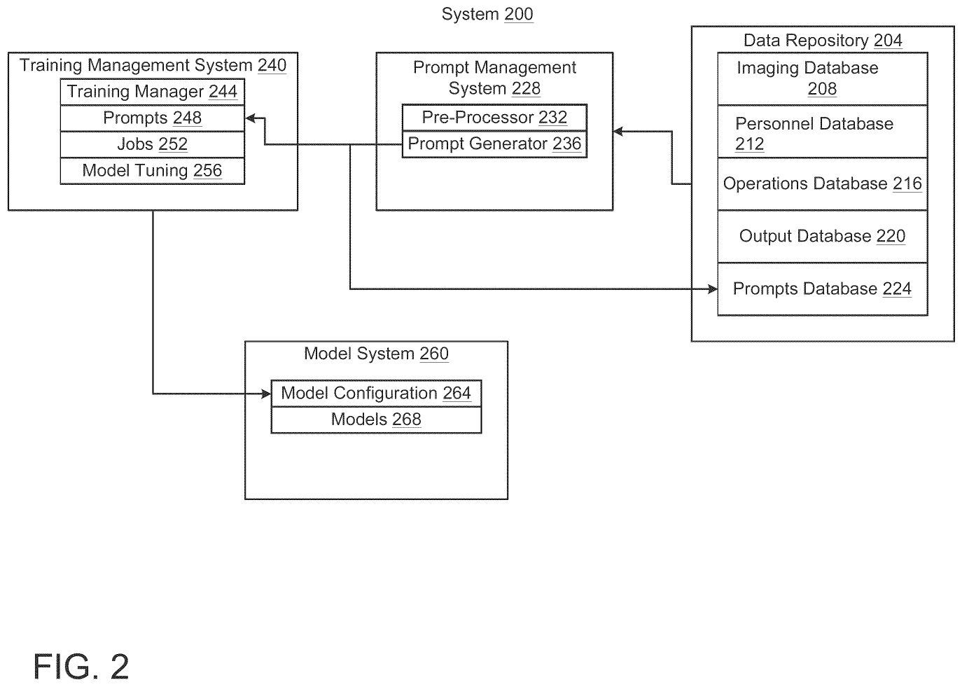

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to enable generative AI applications for building managements systems and security operations, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 204, and determine training data elements that include examples of input and outputs for generation by machine learning models, such as a training data element that includes a prompt and a completion corresponding to the prompt, based on the data from the data repository 204.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

As an exemplary implementation, the models 268 may include a visual language model (VLM) (e.g., pre-trained VLM). In this implementation, the system 200 may be configured to generate a text-video dataset for a specific task (e.g., video anomaly detection, which contains long, untrimmed surveillance videos). The videos are split into short clips which match the VLM input size. Each clip is then associated with a descriptive text that reflects the content of the clip, such as “normal activity in a parking lot” or “a person setting fire to a vehicle”. Instruction tuning involves creating a set of instruction-response pairs that guide the model on what kind of output is expected. For anomaly detection, an instruction might include: “Identify and describe the anomaly in this video clip.” The corresponding response would include a textual description, such as “A person is breaking into a car,” or a binary classification like “anomalous” or “normal”. These prompts train the VLM to associate specific visual cues in the video with appropriate textual descriptions or anomaly labels, such that the VLM is ultimately trained to understand the context of the instruction and to produce an accurate output based on the video content. In video summarization for anomaly detection, therefore, the VLM is trained to describe the anomalous/normal event in each clip as briefly and accurately as possible.

Additionally or alternatively, in some exemplary implementations, the models 268 may include a LLM (e.g., pre-trained LLM). As described above with reference to the VLM, the LLM may receive instruction tuning such that the LLM is trained to generate a video summary from multiple short clip textual summaries (e.g., produced by the VLM, described above). Therefore, training pairs may include combining multiple clip summaries as the input and creating a corresponding output that is a cohesive summary of the entire video. The prompt for such training may be: “Create a video summary from these clip summaries”, which prompts the LLM to create the summary.

### Application Session Management

FIG. 3 depicts an example of the system 200, in which the system 200 can perform operations to implement at least one application session 308 for a user device 304. For example, responsive to configuring the machine learning models 268, the system 200 can generate data for presentation by the user device 304 (including generating data responsive to information received from the user device 304) using the at least one application session 308 and the one or more machine learning models 268.

The user device 304 can be a device of a user, such as a security officer or building manager. The user device 304 can include any of various wireless or wired communication interfaces to communicate data with the model system 260, such as to provide requests to the model system 260 indicative of data for the machine learning models 268 to generate, and to receive outputs from the model system 260. The user device 304 can include various user input and output devices to facilitate receiving and presenting inputs and outputs.

In some implementations, the system 200 provides data to the user device 304 for the user device 304 to operate the at least one application session 308. The application session 308 can include a session corresponding to any of the applications 120 described with reference to FIG. 1. For example, the user device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the user device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which may include at least one of the first prompt or the first completion concatenated to the second prompt), and provide the second completion to the application session 308.

In some implementations, the application session 308 maintains a session state regarding the application session 308. The session state can include one or more prompts received by the application session 308, and can include one or more completions received by the application session 308 from the model system 260. The session state can include one or more items of feedback received regarding the completions, such as feedback indicating accuracy of the completion. The system 200 can include or be coupled with one or more session inputs 340 or sources thereof. The session inputs 340 can include, for example and without limitation, location-related inputs, such as identifiers of an entity managing security operation or a building or building management system, a jurisdiction (e.g., city, state, country, etc.), a language, or a policy or configuration associated with the security operation, building, or building management system. The session inputs 340 can indicate an identifier of the user of the application session 308. The session inputs 340 can include data regarding security operations or building management systems, including but not limited to operation data or sensor data. The session inputs 340 can include information from one or more applications, algorithms, simulations, neural networks, machine learning models, or various combinations thereof, such as to provide analyses, predictions, or other information regarding security operations. The session inputs 340 can include data from or analogous to the data of the data repository 204.

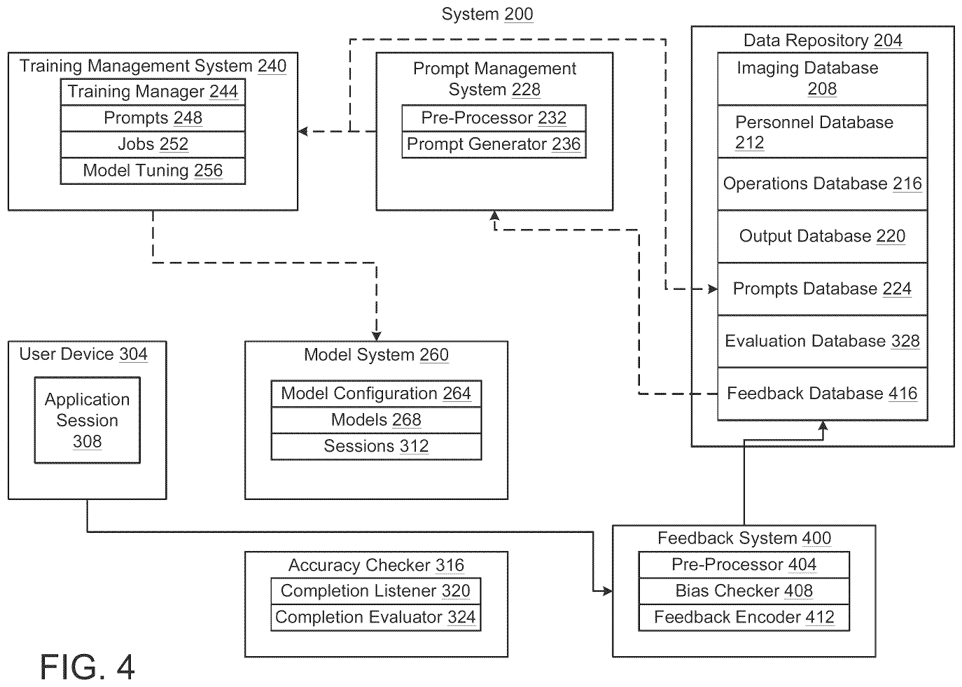

In some implementations, the model system 260 includes at least one sessions database 312. The sessions database 312 can maintain records of application session 308 implemented by user devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268. The sessions database 312 can include one or more session states of the application session 308.

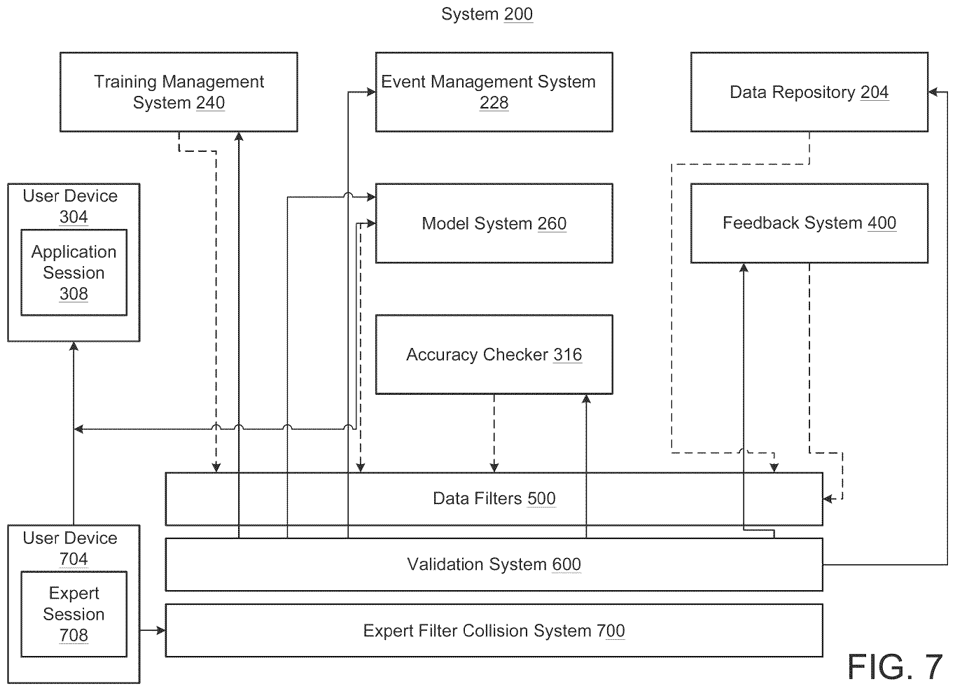

As depicted in FIG. 3, the system 200 can include at least one pre-processor 332. The pre-processor 332 can evaluate the prompt according to one or more criteria and pass the prompt to the model system 260 responsive to the prompt satisfying the one or more criteria, or modify or flag the prompt responsive to the prompt not satisfying the one or more criteria. The pre-processor 332 can compare the prompt with any of various predetermined prompts, thresholds, outputs of algorithms or simulations, or various combinations thereof to evaluate the prompt. The pre-processor 332 can provide the prompt to an expert system (e.g., expert system 700 described with reference to FIG. 7) for evaluation. The pre-processor 332 (and/or post-processor 336 described below) can be made separate from the application session 308 and/or model system 260, which can modularize overall operation of the system 200 to facilitate regression testing or otherwise enable more effective software engineering processes for debugging or otherwise improving operation of the system 200. The pre-processor 332 can evaluate the prompt according to values (e.g., numerical or semantic/text values) or thresholds for values to filter out of domain inputs, such as inputs targeted for jail-breaking the system 200 or components thereof, or filter out values that do not match target semantic concepts for the system 200.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 260 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

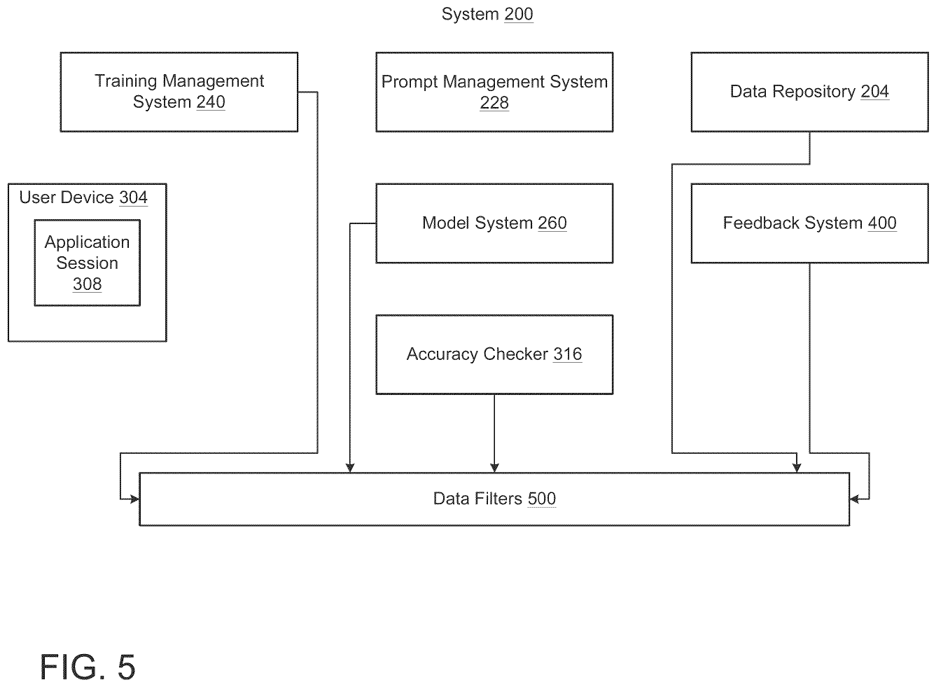

The accuracy checker 316 can include or be coupled with at least one post-processor 336. The post-processor 336 can perform various operations to evaluate, validate, and/or modify the completions generated by the model system 260. In some implementations, the post-processor 336 includes or is coupled with data filters 500, validation system 600, and/or expert system 700 described with reference to FIGS. 5-7. The post-processor 336 can operate with one or more of the accuracy checker 316, external systems 344, operations data 348, and/or role models 360 to query databases, knowledge bases, or run simulations that are granular, reliable, and/or transparent.

Referring further to FIG. 3, the system 200 can include or be coupled with one or more external systems 344. The external systems 344 can include any of various data sources, algorithms, machine learning models, simulations, internet data sources, or various combinations thereof. The external systems 344 can be queried by the system 200 (e.g., by the model system 260) or the pre-processor 332 and/or post-processor 336, such as to identify thresholds or other baseline or predetermined values or semantic data to use for validating inputs to and/or outputs from the model system 260. The external systems 344 can include, for example and without limitation, documentation sources associated with an entity that manages security operations.

The system 200 can include or be coupled with operations data 348. The operations data 348 can be part of or analogous to one or more data sources of the data repository 204. The operations data 348 can include, for example and without limitation, data regarding real-world operations of building management systems, such as changes in building policies, building states, results of security systems or other operations, performance indices, or various combinations thereof. The operations data 348 can be retrieved by the application session 308, such as to condition or modify prompts and/or requests for prompts on operations data 348.

### Role-Specific Machine Learning Models

As depicted in FIG. 3, in some implementations, the models 268 can include or otherwise be implemented as one or more role-specific models 360. The models 360 can be configured using training data (and/or have tuned hyperparameters) representative of particular tasks associated with generating accurate completions for the application sessions 308 such as to perform iterative communication of various language model job roles to refine results internally to the model system 260 (e.g., before/after communicating inputs/outputs with the application session 308), such as to validate completions and/or check confidence levels associated with completions. By incorporating distinct models 360 (e.g., portions of neural networks and/or distinct neural networks) configured according to various roles, the models 360 can more effectively generate outputs to satisfy various objectives/key results.

For example, the role-specific models 360 can include one or more of an author model 360, an editor model 360, a validator model 360, or various combinations thereof. The author model 360 can be used to generate an initial or candidate completion, such as to receive the prompt (e.g., via pre-processor 332) and generate the initial completion responsive to the prompt. The editor model 360 and/or validator model 360 can apply any of various criteria, such as accuracy checking criteria, to the initial completion, to validate or modify (e.g., revise) the initial completion. For example, the editor model 360 and/or validator model 360 can be coupled with the external systems 344 to query the external systems 344 using the initial completion (e.g., to detect a difference between the initial completion and one or more expected values or ranges of values for the initial completion), and at least one of output an alert or modify the initial completion (e.g., directly or by identifying at least a portion of the initial completion for the author model 360 to regenerate). In some implementations, at least one of the editor model 360 or the validator model 360 are tuned with different hyperparameters from the author model 360, or can adjust the hyperparameter(s) of the author model 360, such as to facilitate modifying the initial completion using a model having a higher threshold for confidence of outputted results responsive to the at least one of the editor model 360 or the validator model 360 determining that the initial completion does not satisfy one or more criteria. In some implementations, the at least one of the editor model 360 or the validator model 360 is tuned to have a different (e.g., lower) risk threshold than the author model 360, which can allow the author model 360 to generate completions that may fall into a greater domain/range of possible values, while the at least one of the editor model 360 or the validator model 360 can refine the completions (e.g., limit refinement to specific portions that do not meet the thresholds) generated by the author model 360 to fall within appropriate thresholds (e.g., rather than limiting the threshold for the author model 360).

For example, responsive to the validator model 360 determining that the initial completion includes a value (e.g., setpoint to meet a target value of a performance index) that is outside of a range of values validated by a simulation for an item of equipment, the validator model 360 can cause the author model 360 to regenerate at least a portion of the initial completion that includes the value; such regeneration may include increasing a confidence threshold for the author model 360. The validator model 360 can query the author model 360 for a confidence level associated with the initial completion, and cause the author model 360 to regenerate the initial completion and/or generate additional completions responsive to the confidence level not satisfying a threshold. The validator model 360 can query the author model 360 regarding portions (e.g., granular portions) of the initial completion, such as to request the author model 360 to divide the initial completion into portions, and separately evaluate each of the portions. The validator model 360 can convert the initial completion into a vector, and use the vector as a key to perform a vector concept lookup to evaluate the initial completion against one or more results retrieved using the key.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the user device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, security reports, or Wikipedia-type documentation.

In some implementations, the feedback system 400 includes a pre-processor 404. The pre-processor 404 can perform any of various operations to modify the feedback for further processing. For example, the pre-processor 404 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

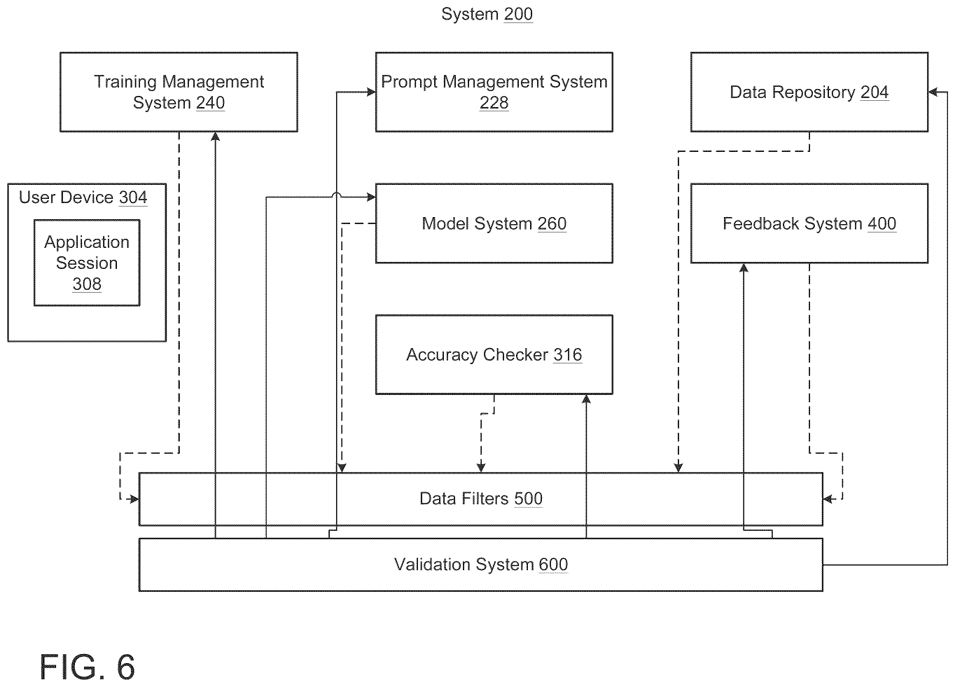

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can enable the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

The system 200 can determine the thresholds using the feedback system 400 and/or the user device 304, such as by providing a request for feedback that includes a request for a corresponding threshold associated with the completion and/or prompt presented by the application session 308. In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, user device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can enable the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the user device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., executive officials, security personnel) and/or expert systems (e.g., data validation systems that can implement processes analogous to those described with reference to the data filters 500) to receive data of the system 200 and modify, validate, or otherwise process the data. For example, the validation system 600 can provide to human executive officials, security personnel, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can enable the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of user device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can enable the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can be accessed via an expert session 708 of a user device 704. For example, via the expert session 708, the expert system 700 can enable functions such as receiving inputs for a human expert to provide feedback to a user of the user device 304; a human expert to guide the user through the data (e.g., completions) provided to the user device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the user device 704. For example, the expert system 700 can receive feedback regarding the data for modifying or validating the data (e.g., editing or validating completions). In some implementations, the expert system 700 requests at least one of an identifier or a credential of a user of the user device 704 prior to providing the data to the user device 704 and/or requesting feedback regarding the data from the expert session 708. For example, the expert system 700 can request the feedback responsive to determining that the at least one of the identifier or the credential satisfies a target value for the data. This can allow the expert system 700 to selectively identify experts to use for monitoring and validating the data.

In some implementations, the expert system 700 facilitates a communication session regarding the data, between the application session 308 and the expert session 708. For example, the expert session 708, responsive to detecting presentation of the data via the application session 308, can request feedback regarding the data (e.g., user input via the application session 308 for feedback regarding the data), and provide the feedback to the user device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., building employee or executive official) to receive expert feedback from a user of the user device 704 (e.g., security officer). In some implementations, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The user device 304 can communicate with the system 200 via the building data platform, and can send feedback, reports, and other data to the building data platform. In some implementations, the data repository 204 maintains building data platform-specific databases, such as to enable the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application number 202341008712, filed Feb. 10, 2023, the disclosures of which are incorporated herein by reference in their entireties.

### III. Generative Ai-Based Systems and Methods for Security Operations

As described above, systems and methods in accordance with the present disclosure can use machine learning models, including LLMs and other generative AI models, to ingest data regarding building management systems and security operations in various unstructured and structured formats, and generate completions and other outputs targeted to provide useful information to users. Various systems and methods described herein can use machine learning models to support applications for presenting data with high accuracy and relevance.

### Implementing GAI Architectures for Building Management Systems

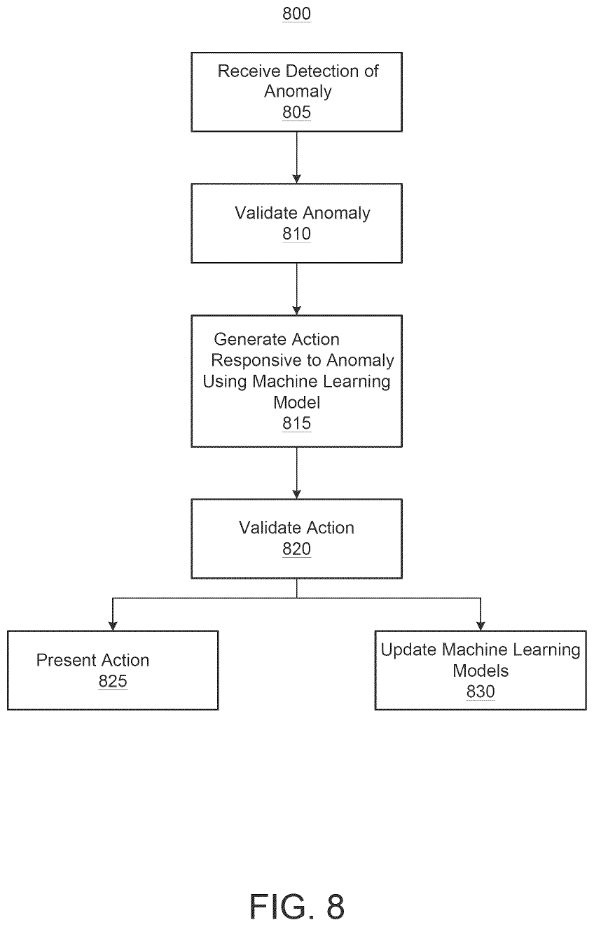

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures. As described with respect to various aspects of the system 200 (e.g., with reference to FIGS. 3-7), the method 800 can implement operations to facilitate more accurate, precise, and/or timely determination of completions to prompts from users regarding security operations, such as to incorporate various validation systems to improve accuracy from generative models.

At 805, a detected anomaly can be received. The detected anomaly can be received using a user interface implemented by an application session of a user device. The detected anomaly can be received in any of various data formats, such as text, audio, speech, image, and/or video formats. The detected anomaly can indicate a request for an action to perform in response to the detected anomaly. In some implementations, the application session provides a conversational interface or chatbot for receiving the detected anomaly, and can present queries via the application to request information for the detected anomaly. For example, the application session can determine that the detected anomaly indicates a type of event, and can request information regarding expected issues regarding the event (e.g., via iterative generation of completions and communication with machine learning models).

At 810, the detected anomaly is validated. For example, criteria such as one or more rules, heuristics, models, algorithms, thresholds, policies, or various combinations thereof can be evaluated using the detected anomaly. In some implementations, the detected anomaly can be evaluated by a pre-processor that may be separate from at least one of the application session or the machine learning models. In some implementations, the detected anomaly can be evaluated using any one or more accuracy checkers, data filters, simulations regarding security operations, or expert validation systems; the evaluation can be used to update the criteria. The detected anomaly can be converted into a vector to perform a lookup in a vector database of expected anomalies or information of anomalies to validate the detected anomaly.

At 815, at least one action is generated using the detected anomaly (e.g., responsive to validating the detected anomaly). The action can be generated using one or more machine learning models, including generative machine learning models. For example, the action can be generated using a neural network comprising at least one transformer, such as GPT model. The action can be generated using image/video generation models, such as GAN and/or diffusion models. The action can be generated based on the one or more machine learning models being configured (e.g., trained, updated, fine-tuned, etc.) using training data examples representative of information for security operations, including but not limited to unstructured data or semi-structured data. Detected anomalies can be iteratively received and actions iteratively generated responsive to the detected anomalies as part of an asynchronous and/or conversational communication session. In some implementations, the action can be generated at least in part using a multi-modal model trained on combinations of image/video and text data, such as CLIP and/or CLIP4Clip.

In some implementations, generating the detected anomaly comprises using a plurality of machine learning models, which may be configured in similar or different manners, such as by using different training data, model architectures, parameter tuning or hyperparameter fine tuning, or various combinations thereof. In some implementations, the machine learning models are configured in a manner representative of various roles, such as author, editor, validation, external data comparison, etc. roles. For example, a first machine learning model can operate as an author model, such as to have relatively fewer/lesser criteria for generating an initial action responsive to the detected anomaly, such as to require relatively lower confidence levels or risk criteria. A second machine learning model can be configured to have relatively greater/higher criteria, such as to receive the initial action, process the initial action to detect one or more data elements (e.g., tokens or combinations of tokens) that do not satisfy criteria of the second machine learning model, and output an alert or cause the first machine learning model to modify the initial action responsive to the valuation. For example, the editor model can identify a phrase in the initial action that does not satisfy an expected value (e.g., expected accuracy criteria determined by evaluating the detected anomaly using a simulation), and can cause the first machine learning model to provide a natural language explanation of factors according to which the initial action was determined, such as to present such explanations via the application session. The machine learning models can evaluate the actions according to bias criteria. The machine learning models can store the actions and detected anomalies as data elements for further configuration of the machine learning models (e.g., positive/negative examples corresponding to the detected anomalies).

At 820, the action can be validated. The action can be validated using various processes described for the machine learning models, such as by comparing the action to any of various thresholds or outputs of databases or simulations. For example, the machine learning models can configure calls to databases or simulations for the security operation indicated by the detected anomaly to validate the action relative to outputs retrieved from the databases or simulations. The action can be validated using accuracy checkers, bias checkers, data filters, or expert systems.

At 825, the action is presented via the application session. For example, the action can be presented as any of text, speech, audio, image, and/or video data to represent the action, such as to provide an answer to a query represented by the detected anomaly regarding a security operation or building management system. The action can be presented via iterative generation of actions responsive to iterative receipt of detected anomalies. The action can be present with a user input element indicative of a request for feedback regarding the action, such as to enable the detected anomaly and action to be used for updating the machine learning models.

At 830, the machine learning model(s) used to generate the action can be updated according to at least one of the detected anomaly, the action, or the feedback. For example, a training data element for updating the model can include the detected anomaly, the action, and the feedback, such as to represent whether the action appropriately satisfied a user's request for information regarding the security operation. The machine learning models can be updated according to indications of accuracy determined by operations of the system such as accuracy checking, or responsive to evaluation of actions by experts (e.g., responsive to selective presentation and/or batch presentation of detected anomalies and actions to experts).

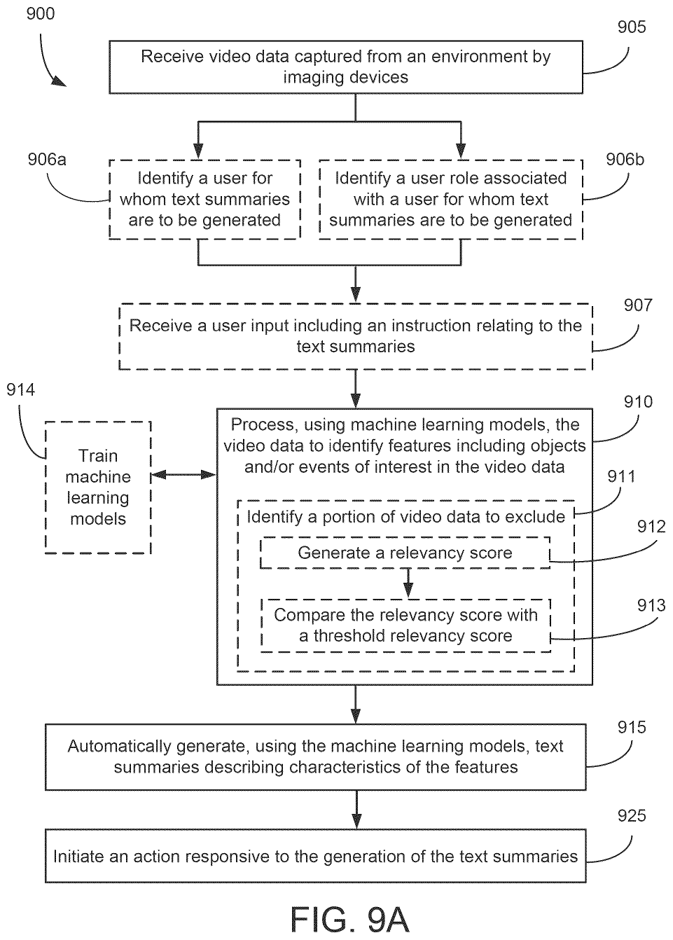

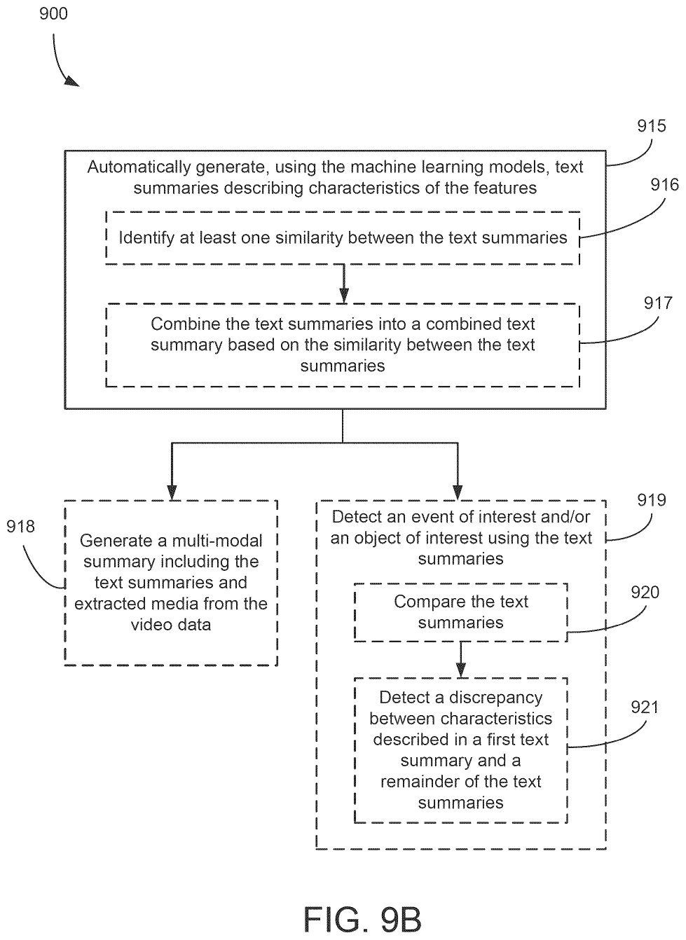

Referring to FIG. 9A, a flow diagram of a method 900 of using machine learning models to generate text summaries of video footage from a security system is shown, according to various embodiments. In some embodiments, the machine learning models may include one or more generative AI models. The method 900 can be performed using various devices and systems described herein, including but not limited to the systems 100, 200 or one or more components thereof. Various aspects of the method 900 can be implemented using one or more devices or systems that are communicatively coupled with one another, including in client-server, cloud-based, or other networked architectures.

The method 900 is shown to include receiving video data captured from an environment by imaging devices at step 905. The imaging devices may include security cameras installed in the environment, and the video data may include video footage captured by one or more of the security cameras. In some embodiments, the environment refers to a building or a space of a building.

In some embodiments, a user for whom text summaries are to be generated is identified at step 906a. For example, the user may include first-party personnel associated with the facility (e.g., a security operator, a facility manager, a custodian, a maintenance technician, etc.).

Alternatively or additionally, in some embodiments, a user role associated with the user for whom text summaries are to be generated is identified at step 906b. That is, the user role may define various permissions, responsibilities, and so on, of the user.

In certain implementations, method 900 may include receiving a user input including an instruction relating to the text summaries at step 907.

At step 910, the video data may be processed, using machine learning models, to identify one or more features in the video data. The one or more features may include at least one of objects of interest in the video data or events of interest in the video data.

In some embodiments, where the method 900 includes receiving a user input including an instruction relating to the text summaries at step 907, the data may be processed at step 910 based upon the received user input.

In various instances where the method 900 includes identifying a user at step 906a, the video data may be processed based upon the identified user such that the one or more features in the video data identified based upon a first user differ from the one or more features in the video data identified based upon a second user. For example, a first security officer may prefer to receive a text summary of the video data including a first set of objects and/or events of interest (e.g., an unaccompanied child, an unaccompanied bag, an unauthorized person entering a restricted area, etc.), while a second security officer may prefer to receive a text summary of the video data including a second set of objects and/or events of interest (e.g., a person running, a person yelling, a physical altercation, etc.). In this way, the video data may be processed such that the text summary for the first security officer includes the first set of objects and/or events of interest, while the text summary for the second security officer includes the second set of objects and/or events of interest.

In various instances where the method 900 includes identifying a user role at step 906b, the video data may be processed based upon the identified user role such that the one or more features in the video data identified based upon a first user role differ from the one or more features in the video data identified based upon a second user role. For example, a security officer may receive a text summary of the video data including a first set of objects and/or events of interest (e.g., an unaccompanied child, a door propped open, broken glass, etc.) relevant to responsibilities of the security officer, while a custodian may receive a text summary of the video data including a second set of objects and/or events of interest (e.g., a spill on the floor, an overflowing trash can, broken glass, etc.) relevant to responsibilities of the custodian. In this way, the video data may be processed such that the text summary for the security officer includes the first set of objects and/or events of interest, while the text summary for the custodian includes the second set of objects and/or events of interest.

In some embodiments, where the method 900 includes identifying the user role at step 906b, the video data may be processed by a role-specific machine learning model, with the role-specific machine learning model corresponding to the user role identified at step 906b. That is, if a first user role is identified for a first user, the machine learning model used to process the video data at step 910 may differ from a machine learning model used to process the video data at step 910 during instances where a second user role is identified for a second user. In this way, the one or more features in the video data identified based upon the first user differ from the one or more features in the video data identified based upon the second user.

Alternatively, the video data may be processed by a single machine learning model for a plurality of user roles. In this instance, the single machine learning model may be trained using training data related to the plurality of user roles such that when the method 900 includes identifying the user role at step 906b, the machine learning model may still process the video data based upon the identified user role.

In some embodiments, processing the video data at step 910 may include identifying a portion of the video data to exclude from being described in the one or more text summaries at step 911.

For instance, according to some embodiments, the portion of the video data to exclude is identified based upon at least one of a threshold length for the text summaries. That is, in such instances, the portion of the video data may be excluded based upon an inclusion of the portion of the video data causing a length of the text summary to exceed the threshold length.

Alternatively or additionally, the portion of the video data to exclude may be identified based upon a predetermined number of features to be identified in the video data. That is, in such instances, the portion of the video data may be excluded based upon an inclusion of the portion of the video data causing a number of features to be identified in the video data to exceed the predetermined number of features.

That is, in some embodiments, identifying the portion of video data to exclude at step 911 further includes generating a relevancy score at step 912 using the machine learning models. Step 912 may include generating a relevancy score for the features identified in the video data.

Step 911 may also include comparing the relevancy scores associated the features (e.g., generated at step 912) to a threshold relevancy score at step 913. In such instances, the identification of the portion of video data to exclude at step 911 may be based upon the portion of the video data including at least one feature corresponding to a relevancy score that is below the threshold relevancy score.

In some embodiments, method 900 may include training the machine learning models at step 914. The machine learning models may be trained using a training dataset, where the training dataset includes a plurality of images and a plurality of textual descriptions corresponding to the plurality of images.

At step 915, text summaries describing one or more characteristics of the one or more features may be automatically generated using the machine learning models. In some embodiments, step 915 may include generating a single text summary describing the one or more characteristics of the one or more features. Alternatively or additionally, step 915 may include generating a plurality of text summaries.

In some embodiments, where the method 900 includes identifying the user at step 906a, the text summaries may be generated based at least in part on the identified user.

For instance, generating the text summaries based at least in part on the identified user may include determining a length of the text summaries based upon a preference of the identified user, and generating the text summaries according to the preferred length of the identified user.

Alternatively or additionally, generating the text summaries based at least in part on the identified user may include determining a content of the text summaries based upon a preference of the identified user, and generating the text summaries according to the preferred content of the identified user.

Additionally or alternatively, generating the text summaries based at least in part on the identified user may include determining a frequency of providing the text summaries based upon a preference of the identified user, and generating the text summaries according to the preferred frequency of the identified user.

Additionally or alternatively, generating the text summaries based at least in part on the identified user may include determining a notification method by which the text summaries are provided based upon a preference of the identified user, and generating the text summaries according to the preferred notification method of the identified user.

In some embodiments, where the method 900 includes identifying the user role at step 906b, the text summaries may be generated based at least in part on the identified user role.

For instance, generating the text summaries based at least in part on the identified user role may include determining a length of the text summaries based upon the identified user role, and generating the text summaries according to the length associated with the identified user role.

Alternatively or additionally, generating the text summaries based at least in part on the identified user role may include determining a content of the text summaries based upon the identified user role, and generating the text summaries according to the determined content associated with the identified user role.

Additionally or alternatively, generating the text summaries based at least in part on the identified user role may include determining a frequency of providing the text summaries based upon the identified user role, and generating the text summaries according to the frequency associated with the identified user role.

Additionally or alternatively, generating the text summaries based at least in part on the identified user role may include determining a notification method by which the text summaries are provided based upon the identified user role, and generating the text summaries according to the notification method associated with the identified user role.

In some embodiments, where the method 900 includes receiving a user input including an instruction relating to the text summaries at step 907, the text summaries may be generated at step 915 based on the received user input.

Referring to FIG. 9B, a flow diagram of additional steps in method 900 is shown, according to various embodiments.

Step 915 is shown to include, according to certain embodiments, identifying at least one similarity between the text summaries at step 916. In such certain embodiments, the at least one similarity may be identified between the plurality of text summaries generated at step 915.

In some embodiments, step 915 also includes combining the plurality of text summaries into a combined text summary at step 917 based on the similarity between the text summaries identified at step 916.

After generating the text summaries at step 915, method 900 may include, in some embodiments, generating a multi-model summary at step 918. The multi-modal summary may include the text summaries generated at step 915 and extracted media from the video data received at step 905. Where the multi-modal summary includes the extracted media from the video data received at step 905, the extracted media may include one or more video portions from the video data. Alternatively or additionally, the extracted media may include one or more images extracted from the video data.

Alternatively or additionally, in some embodiments, method 900 may include detecting an event of interest and/or an object of interest at step 919 using the text summaries generated at step 915. In such embodiments, the event of interest and/or the object of interest may be detected using a plurality of text summaries generated at step 915 that correspond to a plurality of portions of video footage.

In some embodiments, step 919 may include comparing the characteristics described in the plurality of text summaries at step 920.

Step 919 may further include detecting a discrepancy between the characteristics described in a first text summary and characteristics described in a remainder of the text summaries at step 921. The first text summary may correspond to at least one of the plurality of portions of video footage, and the remainder of the text summaries may correspond to the remainder of the plurality of portions of video footage. Therefore, the event of interest and/or the object of interest is identified in the at least one of the plurality of portions of video footage corresponding to the first text summary based upon the discrepancy between the characteristics in the plurality of text summaries.

Referring to FIG. 9A, step 925 of method 900 may include initiating an action responsive to the generation of the text summaries. In some implementations, initiating an action responsive to the generation of the text summaries may include generating a report, notification, or other output of the summaries (e.g., to be provided to a user, such as a building manager). In some implementations, initiating an action may additionally or alternatively include activating an alert or warning responsive to or using the summaries, activating building equipment (e.g., security equipment) responsive to or using the summaries, or any other type of action.

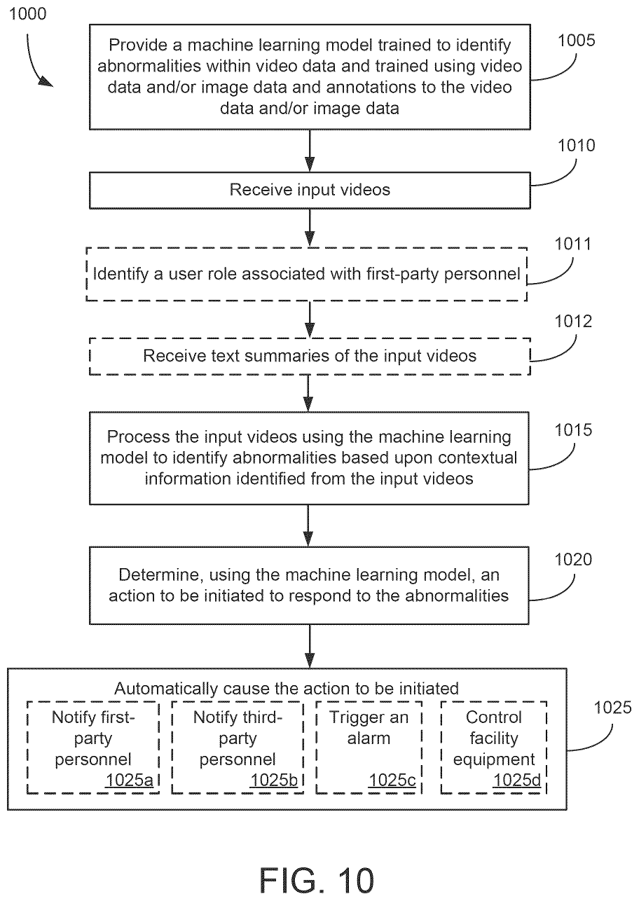

Referring to FIG. 10, a flow diagram of a method 1000 of using machine learning models to automate a system response to an identified abnormality in video footage of a security system is shown, according to some embodiments. In some embodiments, the machine learning models may include one or more generative artificial intelligence models. The method 1000 can be performed using various devices and systems described herein, including but not limited to the systems 100, 200 or one or more components thereof. Various aspects of the method 1000 can be implemented using one or more devices or systems that are communicatively coupled with one another, including in client-server, cloud-based, or other networked architectures.

Step 1005 of method 1000 includes providing a machine learning model trained to identify abnormalities within video data. The machine learning model provided at step 1005 may be trained using video data and/or image data and annotations to the video data and/or image data.

At step 1010, input videos are received.

In some embodiments, method 1000 includes identifying a user role at step 1011. The user role refers to a role associated with first-party personnel of the security system.

Method 1000 may also include, in some embodiments, receiving text summaries of the input videos at step 1012. For example, the text summaries may be the text summaries generated during method 900, as described above.

At step 1015, the input videos are processed using the machine learning model to identify abnormalities. The abnormalities may be identified based upon contextual information identified from the input videos.

In some embodiments, where the method 1000 includes receiving the text summaries of the input videos, the input videos may be processed at step 1015 in response to receiving the text summaries at step 1012.

An action to be initiated in response to the abnormalities identified at step 1015 may be determined at step 1020 using the machine learning model.

In some embodiments, where the method 1000 includes receiving the text summaries of the input videos, the action determined at step 1020 may be determined based upon the text summaries received at step 1012.

In some embodiments, where the method 1000 includes identifying the user role at step 1011, the action determined at step 1020 may depend on the identified user role. For example, if the identified abnormality is of a high severity, the building manager might be notified immediately. Alternatively, the identified abnormality is of a low severity, on-site security may be notified first, such that the building manager is not notified immediately. In such instances, the building manager may never be notified or may be notified only in response to an escalation of the situation and/or lack of a sufficient response from the on-site security.

At step 1025, the action determined at step 1020 is automatically initiated.

In some embodiments, automatically causing the action to be initiated at step 1025 may include notifying the first-party personnel at step 1025a. For example, the first-party personnel may include employees or other personnel associated with an environment from which the input videos are being received.

Alternatively or additionally, step 1025 may include notifying third-party personnel at step 1025b. For example, notifying third-party personnel may include dispatching first responder support such as police officers, firefighters, paramedics, etc.

In some embodiments, step 1025 includes trigger an alarm at step 1025c.

Additionally or alternatively, step 1025 may include controlling facility equipment (e.g., doors, gates, badge readers, lights, sprinklers, etc.) at step 1025d.

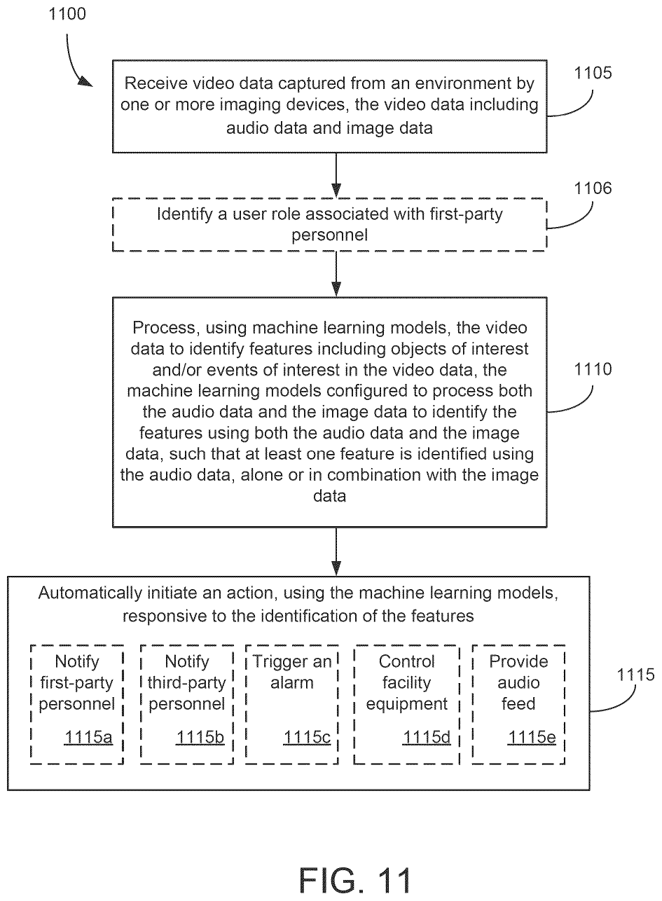

Referring to FIG. 11, a flow diagram of a method 1100 of using machine learning models to process audio data from video footage of a security system is shown, according to some embodiments. In some embodiments, the machine learning models may include one or more generative artificial intelligence models. The method 1100 can be performed using various devices and systems described herein, including but not limited to the systems 100, 200 or one or more components thereof. Various aspects of the method 1100 can be implemented using one or more devices or systems that are communicatively coupled with one another, including in client-server, cloud-based, or other networked architectures.

At step 1105, video data captured from an environment by one or more imaging devices is received. The video data includes audio data and image data.

In some embodiments, method 1100 includes identifying a user role associated with first-party personnel at step 1106.

Step 1110 includes processing the video data using machine learning models. The video data is processed to identify features including objects of interest and/or events of interest in the video data. The machine learning models are configured to process both the audio data and the image data to identify the features using both the audio data and the image data, such that at least one feature is identified using the audio data, alone or in combination with the image data.

In some embodiments, where the method 1100 includes identifying the user role at step 1106, the video data may be processed at step 1110 based upon the identified user role.

At step 1115, an action is automatically initiated, using the machine learning models, responsive to the identification of the features.

In some embodiments, where the method 1100 includes identifying the user role at step 1106, the action initiated at step 1115 may depend on the identified user role.

In some embodiments, automatically initiating the action at step 1115 may include notifying the first-party personnel at step 1115a.

Alternatively or additionally, step 1115 may include notifying third-party personnel at step 1115b.

In some embodiments, step 1115 includes trigger an alarm at step 1115c.

Additionally or alternatively, step 1115 may include controlling facility equipment at step 1115d.

Step 1115 may include, in various embodiments, providing an audio feed at step 1115e.

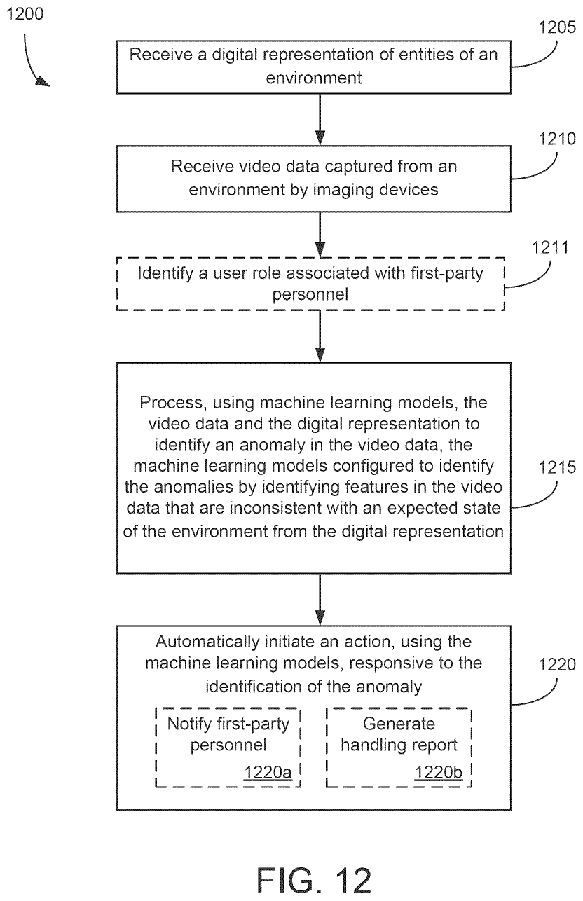

Referring to FIG. 12, a flow diagram of a method 1200 of using machine learning models to track entities within an environment based upon digital representations of the entities is shown, according to some embodiments. In some embodiments, the machine learning models may include one or more generative artificial intelligence models. The method 1200 can be performed using various devices and systems described herein, including but not limited to the systems 100, 200 or one or more components thereof. Various aspects of the method 1200 can be implemented using one or more devices or systems that are communicatively coupled with one another, including in client-server, cloud-based, or other networked architectures.

At step 1205, a digital representation (e.g., a digital twin) of entities of an environment is received.

At step 1210, video data captured from an environment by imaging devices is received.

In some embodiments, method 1200 includes identifying a user role associated with first-party personnel at step 1211.

At step 1215, the video data and the digital representations are processed using machine learning models to identify an anomaly in the video data. The machine learning models may be configured to identify anomalies by identifying features in the video data that are inconsistent with an expected state of the environment from the digital representation.

Method 1200 also includes automatically initiating an action using the machine learning models at step 1220 responsive to the identification of the anomaly from step 1215.

In some embodiments, where the method 1200 includes identifying the user role at step 1211, the action initiated at step 1220 may depend on the identified user role.

In some embodiments, step 1220 may include notifying first-party personnel at step 1220a.

Alternatively or additionally, step 1220 may include generating a handling report at step 1220b.

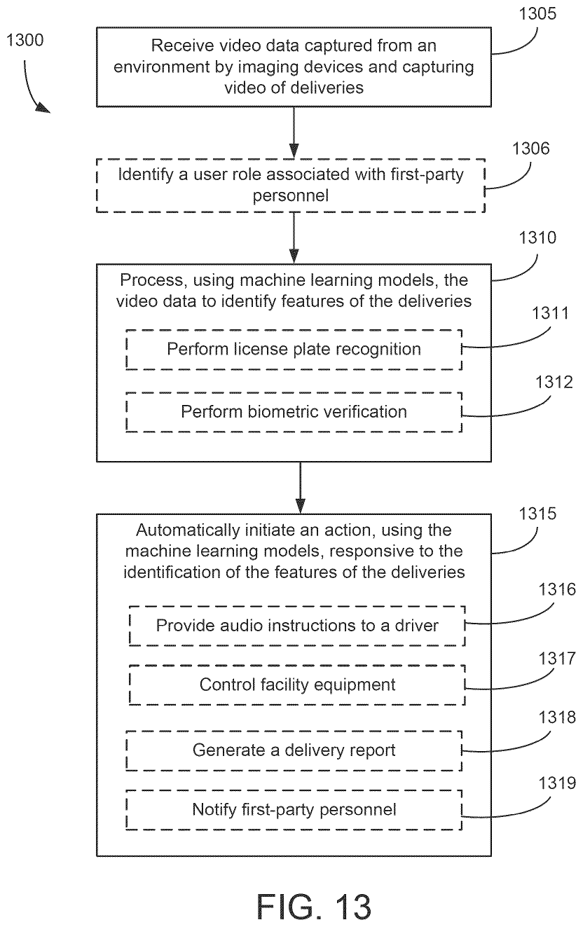

Referring to FIG. 13, a flow diagram of a method 1300 of using machine learning models to supervise a delivery to a facility is shown, according to some embodiments. In some embodiments, the machine learning models may include one or more machine learning models. The method 1300 can be performed using various devices and systems described herein, including but not limited to the systems 100, 200 or one or more components thereof. Various aspects of the method 1300 can be implemented using one or more devices or systems that are communicatively coupled with one another, including in client-server, cloud-based, or other networked architectures.

At step 1305, video data captured from an environment by imaging devices is received. The video data captures video of deliveries to the environment.

In some embodiments, method 1300 includes identifying a user role associated with first-party personnel at step 1306.

At step 1310, the video data is processed using machine learning models to identify features of the deliveries captured by the video data.

In some embodiments, where the method 1300 includes identifying the user role at step 1306, the video data may be processed at step 1310 based upon the identified user role.

In some embodiments, processing the video data at step 1310 may include performing license plate recognition at step 1311.

Alternatively or additionally, processing the video data at step 1310 may include performing biometric verification at step 1312.

At step 1315, an action is automatically initiated using the machine learning models responsive to the identification of the features of the deliveries from step 1310.

In some embodiments, where the method 1300 includes identifying the user role at step 1306, the action initiated at step 1315 may depend on the identified user role.

In some embodiments, the action automatically initiated at step 1315 may include providing audio instructions to a driver at step 1316.

Alternatively or additionally, the action automatically initiated at step 1315 may include controlling facility equipment at step 1317.

In some embodiments, step 1315 may include generating a deliver report at step 1318.

According to certain implementations, step 1315 may include notifying first-party personnel at step 1319.

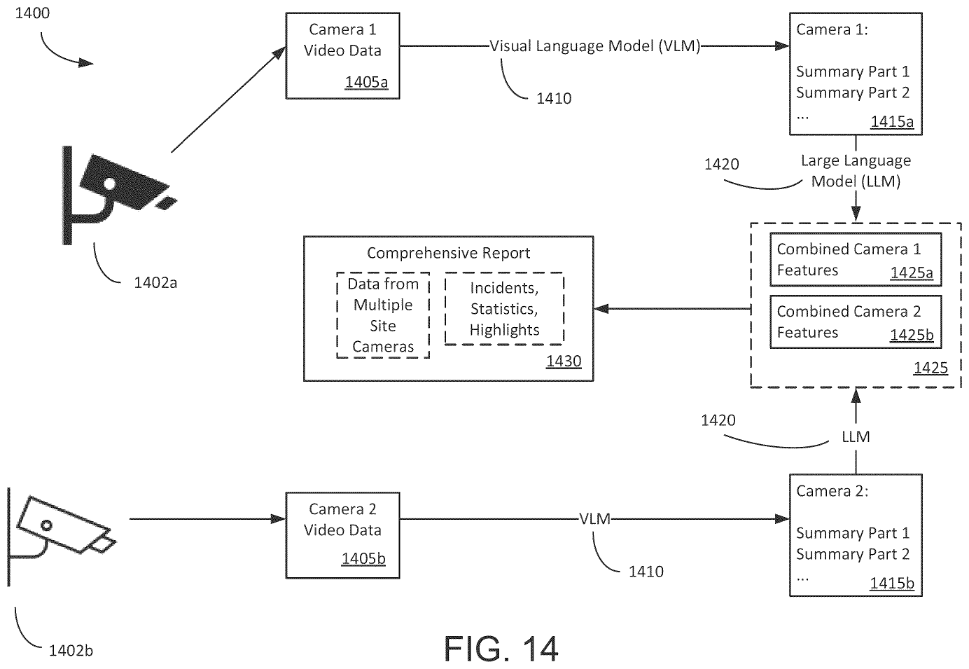

Referring to FIG. 14, a flow diagram of a method 1400 of generating text summaries from video footage is shown, according to an exemplary embodiment. In some embodiments, method 1400 may be an exemplary implementation of the method 900 described above with reference to FIGS. 9A-9B. The method 1400 can be performed using various devices and systems described herein, including but not limited to the systems 100, 200 or one or more components thereof. Various aspects of the method 1400 can be implemented using one or more devices or systems that are communicatively coupled with one another, including in client-server, cloud-based, or other networked architectures.

As shown, the method 1400 begins when video data 1405a (e.g., camera 1 video data), 1405b (e.g., camera 2 video data) is received from cameras 1402a (e.g., camera 1), 1402b (e.g., camera 2), respectively. The cameras 1402a, 1402b may refer to the imaging devices and the video data 1405a, 1405b to the video data received from the imaging devices at step 905 of method 900.

After receiving the video data 1405a, 1405b from the cameras 1402a, 1402b, the video data 1405a, 1405b may be processed using a visual language model (VLM) 1410. In some embodiments, the VLM 1410 may be the machine learning model used to process the video data at step 910 of method 900.

The VLM 1410 may be configured to generate a plurality of summary components 1415a, 1415b from the video data 1405a, 1405b. As shown in FIG. 14, the plurality of summary components 1415a, 1415b include first summary components (e.g., “Summary Part 1” and “Summary Part 2” included in 1415a) corresponding to video data (e.g., 1405a) received from a first camera (e.g., 1402a), and second summary components (e.g., “Summary Part 1” and “Summary Part 2” included in 1415b) corresponding to video data (e.g., 1405b) received from a second camera (e.g., 1402b). That is, each of the summary components 1415a, 1415b includes features from a single camera (e.g., camera 1402a, camera 1402b, respectively). In some embodiments, the plurality of summary components 1415a, 1415b may include the one or more features identified at step 910 of method 900.

A large language model (LLM) 1420 may process the plurality of summary components 1415a, 1415b. That is, the LLM 1420 is configured to combine the plurality of summary components 1415a, 1415b into a combined summary 1425. As shown in FIG. 14, the combined summary 1425 may include combined camera 1 features 1425a from the first summary components (e.g., from 1415a) and combined camera 2 features 1425b from the second summary components (e.g., from 1415b). That is, the combined summary 1425 includes features from multiple cameras (e.g., camera 1402a, camera 1402b).

In some embodiments, the combined summary 1425 may be one of the text summaries generated at step 915 of method 900. In this way, the machine learning model used to generate the text summaries at step 915 may be the LLM 1420.

From the combined summary 1425, the method 1400 includes generating a comprehensive report 1430. The comprehensive report 1430 may, for example, be a daily executive summary of video data automatically sent to relevant personnel (e.g., building managers, security officers, executives, etc.). As shown in FIG. 14, the comprehensive report 1430 includes data from multiple site cameras (e.g., the one or more imaging devices in the environment, as described above with reference to FIGS. 9A and 9B). The data from the multiple site cameras included in the comprehensive report 1430 may include incidents, statistics, highlights, and so on.

In some embodiments, the comprehensive report 1430 may be the report generated during step 925 of method 900, as described above.

### IV. Systems and Methods Utilizing Language-Vision Artificial Intelligence

### Overview

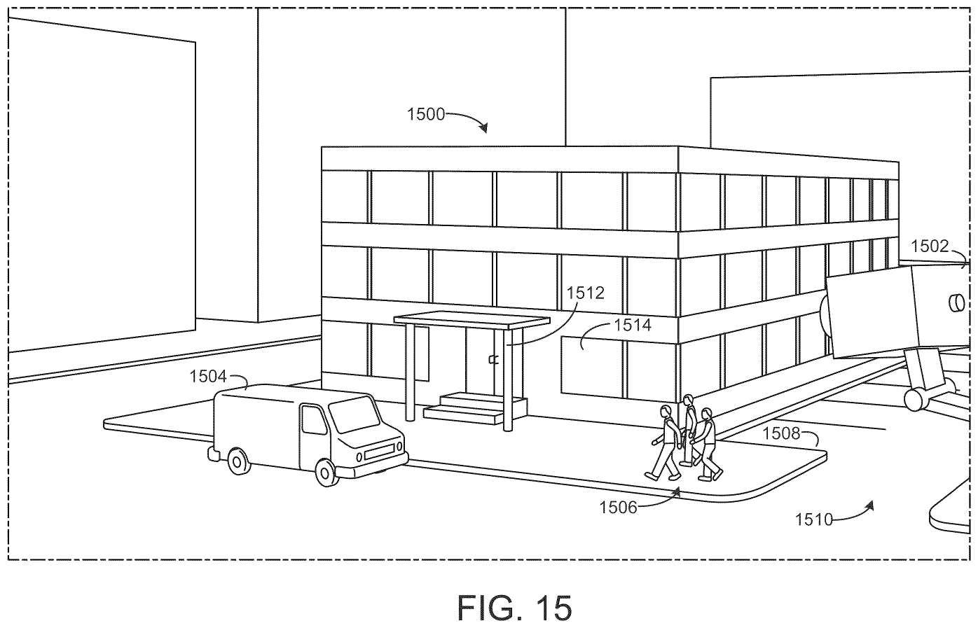

Referring generally to FIGS. 15-32, a building security system with video analysis is shown, according to an exemplary embodiment. The security system may be used in a building, facility, campus, or other physical location to analyze video data received from cameras or other input devices. The security system may use an artificial intelligence (AI) model (e.g., a foundation AI model, a generative AI model, etc.) to recognize particular objects, events, or other entities in video data and may add supplemental annotations to a video stream denoting the recognized objects or events. For example, the artificial intelligence model may be trained to identify contextual information and/or abnormalities within the video data, as described in greater detail below. In some embodiments, in response to detecting an object or event, the security system may trigger a particular function such as generating an incident report, retrieving video footage, performing a risk analysis, dispatching first responder support, activating one or more alarms, or any other security-related function conventionally performed by an operator of the security system.

Systems and methods in accordance with the present disclosure can implement various features to precisely generate data relating to operations to be performed for managing building security. For example, various systems described herein can be implemented to more precisely generate data for various applications including, for example and without limitation, providing a chatbot configured to receive and respond to a user query relating to building activity and providing a virtual security agent configured to automatically perform operator functions including generating incident reports regarding abnormal building activity, performing a risk analysis of an event identified from the building activity, dispatching first responder support, retrieving video footage relevant to an abnormality detected from the building activity, and activating one or more alarms within the building. Various such applications can facilitate both asynchronous and real-time security operations, including by generating response data for such applications based on data from disparate data sources that may not have predefined database associations amongst the data sources, yet may be relevant at specific steps or points in time during security operations.

In some embodiments, the security system includes a language-vision system configured to analyze and search video data for specific objects or events. The language-vision system may use natural language processing to parse a query (e.g., a natural language input) from a user and extract relevant entities (e.g., objects, events, etc.) from the natural language input. The natural language input can include freeform text, verbal or audio input, or any other modality of user input. The language-vision system may then use the extracted entities as search parameters to identify video footage (e.g., clips) and/or images that contain the objects, events, or other entities. The video footage and/or images can be presented via a user interface based on relevancy and can be viewed or played directly from the user interface. In this way, the language-vision system may be implemented as a chatbot configured to facilitate a conversational back and forth between the user and the chatbot, wherein the user submits one or more queries and the chatbot generates a response to each of the one or more queries using the video footage and/or images.

In some embodiments, the language-vision system can refine or update the search results based on additional input (e.g., one or more additional queries) provided via the natural language interface. For example, the AI model can be configured to engage in natural language conversation with a user via the user interface (e.g., functioning as the chatbot) and ask the user questions to help refine the search query and the set of search results. In this way, the user can provide more specific input and the AI model can assist the user in providing additional information to return more relevant, additional, or specific search results. As another example, the initial set of search results may include a video file that depicts a particular person of interest (e.g., a suspected trespasser, a particular employee, etc.). Upon selecting or viewing the initial search results or video file, the user may ask the AI model to “show me all videos or images with this person” and the AI model may run an updated search to find other videos and/or images depicting the same person.

In some embodiments, the language-vision system may be implemented as a virtual agent configured to replace a human operator by automatically performing operator functions based on input video data (e.g., video footage received from one or more cameras implemented within the video security system). That is, the language-vision system may be used to identify one or more abnormalities within the video and, using the trained AI model, determine an appropriate response to the identified abnormality. The appropriate response may, for example, include an operator function such as generating an incident report regarding abnormality, performing a risk analysis of the abnormality, dispatching first responder support, retrieving video footage relevant to the abnormality, and activating one or more alarms within the building. In this way, the virtual agent may provide the function conventionally offered by a live security operator. These and other features and advantages of the building security system and video analysis and search system are described in greater detail below.

### Building Security System

Referring now to FIG. 15, a building 1500 with a security camera 1502 and a parking lot 1510 is shown, according to an exemplary embodiment. The building 1500 is a multi-story commercial building surrounded by, or near, the parking lot 1510 but can be any type of building in some embodiments. The building 1500 may be a school, a hospital, a store, a place of business, a residence, a hotel, an office building, an apartment complex, etc. The building 1500 can be associated with the parking lot 1510.

Both the building 1500 and the parking lot 1510 are at least partially in the field of view of the security camera 1502. In some embodiments, multiple security cameras 1502 may be used to capture the entire building 1500 and parking lot 1510 not in (or in to create multiple angles of overlapping or the same field of view) the field of view of a single security camera 1502. The parking lot 1510 can be used by one or more vehicles 1504 where the vehicles 1504 can be either stationary or moving (e.g., busses, cars, trucks, delivery vehicles). The building 1500 and parking lot 1510 can be further used by one or more pedestrians 1506 who can traverse the parking lot 1510 and/or enter and/or exit the building 1500. The building 1500 may be further surrounded, or partially surrounded, by a sidewalk 1508 to facilitate the foot traffic of one or more pedestrians 1506, facilitate deliveries, etc. In other embodiments, the building 1500 may be one of many buildings belonging to a single industrial park, shopping mall, airport, or commercial park having a common parking lot and security camera 1502. In another embodiment, the building 1500 may be a residential building or multiple residential buildings that share a common roadway or parking lot.

The building 1500 is shown to include a door 1512 and multiple windows 1514. An access control system (ACS) can be implemented within the building 1500 to secure these potential entrance ways of the building 1500. For example, badge readers can be positioned outside the door 1512 to restrict access to the building 1500. The pedestrians 1506 can each be associated with access badges that they can utilize with the ACS to gain access to the building 1500 through the door 1512. Furthermore, other interior doors within the building 1500 can include access readers. In some embodiments, the doors are secured through biometric information, e.g., facial recognition, fingerprint scanners, etc. The ACS can generate events, e.g., an indication that a particular user or a particular badge has interacted with the door. Furthermore, if the door 1512 is forced open, the ACS, via door sensor, can detect the door forced open (DFO) event. As described herein, a virtual agent may detect the DFO event as an abnormality within received video footage (e.g., from at least one of the multiple security cameras 1502) and may automatically perform an operator function in response. For example, the operator function may include notifying a live security officer, generating an incident report related to the DFO event, activating an alarm communicably coupled to the door 1512, retrieving video footage (e.g., a live video feed, stored video clips, static images, etc.) from a security camera 1502 positioned in view of the door 1512, performing a risk analysis of the DFO event, and so on, each of which are described in greater detail herein.

The windows 1514 can be secured by the ACS via burglar alarm sensors. These sensors can be configured to measure vibrations associated with the window 1514. If vibration patterns or levels of vibrations are sensed by the sensors of the window 1514, a burglar alarm can be generated by the ACS for the window 1514. In some embodiments, a virtual agent may be configured to automatically activate the burglar alarm upon receiving abnormal vibration patterns or levels of vibrations sensed by the sensors of the window 1514.

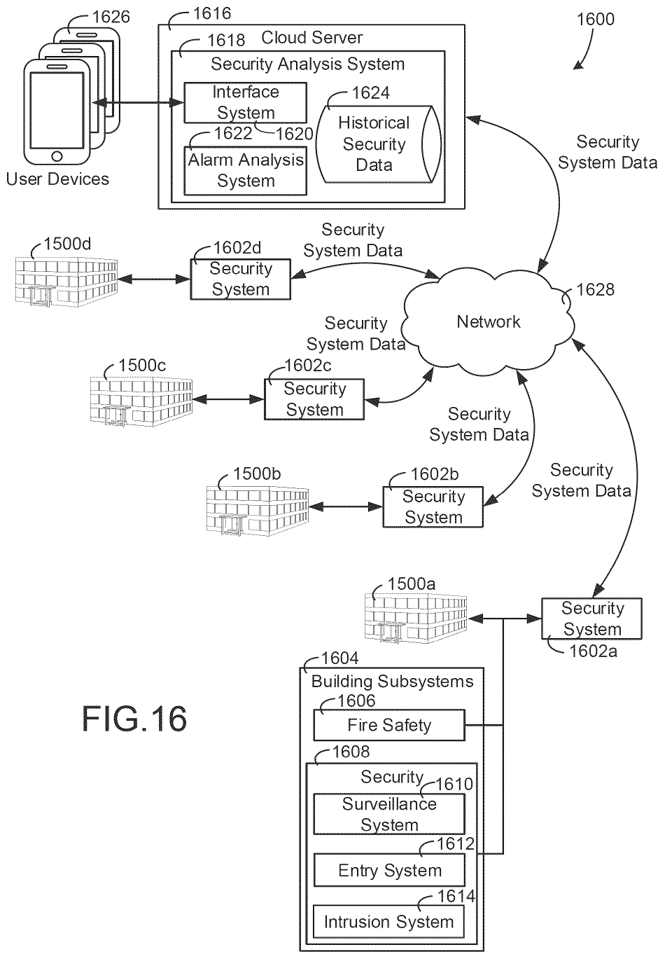

Referring now to FIG. 16, a security system 1600 is shown for multiple buildings, according to an exemplary embodiment. The security system 1600 is shown to include buildings 1500a-1500d. Each of the buildings 1500a-1500d is shown to be associated with a security system 1602a-1602d. The buildings 1500a-1500d may be the same as and/or similar to building 1500 as described with reference to FIG. 15. The security systems 1602a-1602d may be one or more controllers, servers, and/or computers located in a security panel or part of a central computing system for a building.

The security systems 1602a-1602d may communicate with, or include, various security sensors and/or actuators, building subsystems 1604. For example, fire safety subsystems 1606 may include various smoke sensors and alarm devices, carbon monoxide sensors, alarm devices, etc. Security subsystems 1608 are shown to include a surveillance system 1610, an entry system 1612, and an intrusion system 1614. The surveillance system 1610 may include various video cameras, still image cameras, and image and/or video processing systems for monitoring various rooms, hallways, parking lots, the exterior of a building, the roof of the building, etc. The entry system 1612 can include one or more systems configured to allow users to enter and exit the building (e.g., door sensors, turnstiles, gated entries, badge systems, etc.). The intrusion system 1614 may include one or more sensors configured to identify whether a window or door has been forced open. The intrusion system 1614 can include a keypad module for arming and/or disarming a security system and various motion sensors (e.g., IR, PIR, etc.) configured to detect motion in various zones of the building 1500a.

Each of the building subsystems 1604 (e.g., the fire safety subsystems 1606, the security subsystems 1608, etc.) may communicate data received from the various security sensors and/or actuators to an AI model such that the data may be used by a chatbot to provide responses to user queries relating to an abnormality and/or to a virtual agent for determining an appropriate operator function in response to an abnormality. For example, the AI model may receive input data (e.g., video footage) from the surveillance system 1610 showing an unidentified individual attempting to access the building 1500a through a gated entry. In response to the abnormal activity, the virtual agent may activate one or more alarms, retrieve video footage showing the unidentified individual attempting to access the building 1500a, generate an incident report regarding the attempt, and so on. As another example, a user may engage in a conversation with a chatbot regarding an abnormality shown in the video footage received by the AI model from the surveillance system 1610. The chatbot may be configured to provide contextual information relating to the abnormality to the user. More specifically, the chatbot may provide information such as a duration of time that the individual spent attempting to access the building 1500a, items that the individual was wearing, a direction from which the individual approached the gated entry, a direction in which the individual left the gated entry, physical features of the individual, any bystanders to the abnormality, and so on. In some embodiments, a response from the chatbot may further include images and/or videos retrieved from the surveillance system 1610.

Each of buildings 1500a-1500d may be located in various cities, states, and/or countries across the world. There may be any number of buildings 1500a-1500d. The buildings 1500a-1500d may be owned and operated by one or more entities. For example, a grocery store entity may own and operate buildings 1500a-1500d in a particular geographic state. The security systems 1602a-1602d may record data from the building subsystems 1604 and communicate collected security system data to the cloud server 1616 via network 1628.

In some embodiments, the network 1628 communicatively couples the devices, systems, and servers of the system 1600. In some embodiments, the network 1628 is at least one of and/or a combination of a Wi-Fi network, a wired Ethernet network, a ZigBee network, a Bluetooth network, and/or any other wireless network. The network 1628 may be a local area network and/or a wide area network (e.g., the Internet, a building WAN, etc.) and may use a variety of communications protocols (e.g., BACnet, IP, LON, etc.). The network 1628 may include routers, modems, and/or network switches. The network 1628 may be a combination of wired and wireless networks.

The cloud server 1616 is shown to include a security analysis system 1618 that receives the security system data from the security systems 1602a-1602d of the buildings 1500a-1500d. The cloud server 1616 may include one or more processing circuits (e.g., memory devices, processors, databases) configured to perform the various functionalities described herein. The cloud server 1616 may be a private server. In some embodiments, the cloud server 1616 is implemented by a cloud system, examples of which include AMAZON WEB SERVICES® (AWS) and MICROSOFT AZURE®.

A processing circuit of the cloud server 1616 can include one or more processors and memory devices. The processor can be a general purpose or specific purpose processor, an application specific integrated circuit (ASIC), one or more field programmable gate arrays (FPGAs), a group of processing components, or other suitable processing components. The processor may be configured to execute computer code and/or instructions stored in a memory or received from other computer readable media (e.g., CDROM, network storage, a remote server, etc.).

The memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuit and can include computer code for executing (e.g., by the processor) one or more processes described herein.

In some embodiments, the cloud server 1616 can be located on premises within one of the buildings 1500a-1500d. For example, a user may wish that their security, fire, or HVAC data remain confidential and have a lower risk of being compromised. In such an instance, the cloud server 1616 may be located on-premises instead of within an off-premises cloud platform.

The security analysis system 1618 may implement an interface system 1620, an alarm analysis system 1622, and a database storing historical security data 1624 (e.g., security system data collected from the security systems 1602a-1602d). The interface system 1620 may provide various interfaces of user devices 1626 for monitoring and/or controlling the security systems 1602a-1602d of the buildings 1500a-1500d. The interfaces may include various maps, alarm information, maintenance ordering systems, etc. The historical security data 1624 can be aggregated security alarm and/or event data collected via the network 1628 from the buildings 1500a-1500d. The alarm analysis system 1622 can be configured to analyze the aggregated data to identify insights, detect alarms, reduce false alarms, etc. The analysis results of the alarm analysis system 1622 can be provided to a user via the interface system 1620. In some embodiments, the results of the analysis performed by the alarm analysis system 1622 are provided as control actions to the security systems 1602a-1602d via the network 1628.

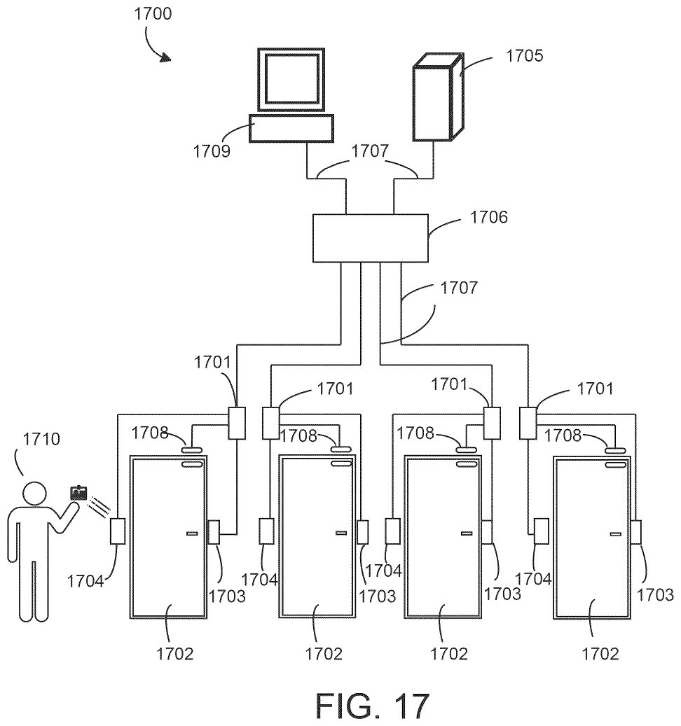

Referring now to FIG. 17, a block diagram of an ACS 1700 is shown, according to an exemplary embodiment. The ACS 1700 can be implemented in any of the buildings 1500a-1500d as described with reference to FIG. 16. The ACS 1700 is shown to include a plurality of doors 1702. Each of the doors 1702 is associated with a door lock 1703, an access reader module 1704, and one or more door sensors 1708. The door locks 1703, the access reader modules 1704, and the door sensors 1708 may be connected to access controllers 1701. The access controllers 1701 may be connected to a network switch 1706 that directs signals, according to the configuration of the ACS 1700, through network connections 1707 (e.g., physical wires or wireless communications links) interconnecting the access controllers 1701 to an ACS server 1705 (e.g., the cloud server 1616). The ACS server 1705 may be connected to an end-user terminal or interface 1709 through network switch 1706 and the network connections 1707.

The ACS 1700 can be configured to grant or deny access to a controlled or secured area. For example, a person 1710 may approach the access reader module 1704 and present credentials, such as an access card. The access reader module 1704 may read the access card to identify a card ID or user ID associated with the access card. The card ID or user ID may be sent from the access reader module 1704 to the access controller 1701, which determines whether to unlock the door lock 1703 or open the door 1702 based on whether the person 1710 associated with the card ID or user ID has permission to access the controlled or secured area.

### Video Analysis System

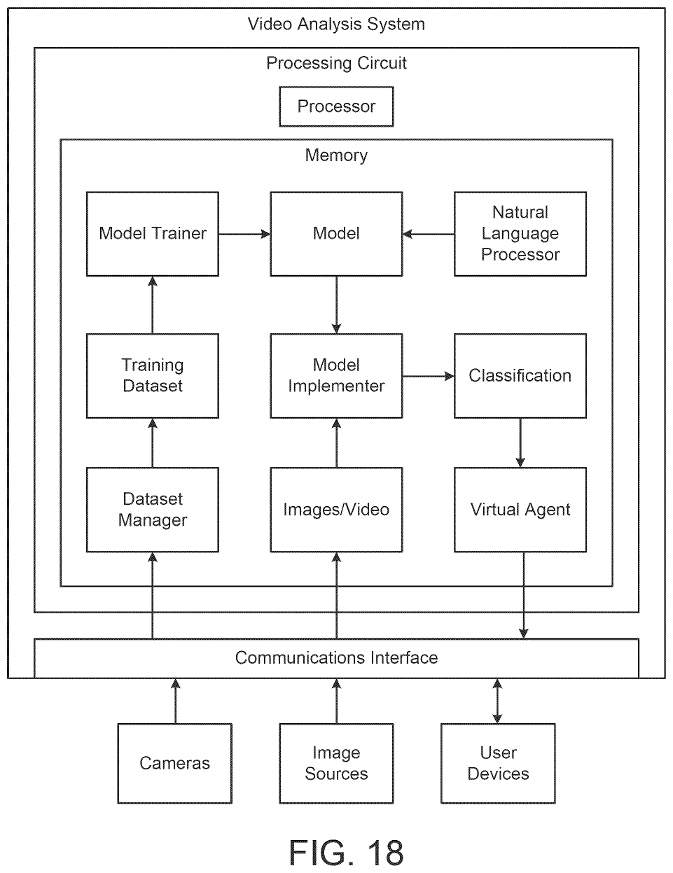

Referring now to FIG. 18, a block diagram of a security system is shown, according to an exemplary embodiment. The security system can be or include one or more of the security systems 1602a-1602d and/or the security analysis system 1618 shown in FIG. 16. The security system is shown to include cameras, image sources, user devices, and a video analysis system. The cameras may include video cameras, surveillance cameras, perimeter cameras, still image cameras, motion activated cameras, infrared cameras, or any other type of camera that can be used in a security system. The image sources can be cameras or other types of image sources such as a computing system, database, and/or server system. The cameras, the image sources, and/or the user devices can be configured to provide video clips, a video feed, images, or other types of visual data to the video analysis system.

The video analysis system can be configured to receive and store the images and video received from the cameras, the image sources, and/or the user devices and process the stored images/video for training and executing a video annotation model (e.g., a machine learning model), according to an exemplary embodiment. The video analysis system can be implemented as part of a security system of the building 1500 as described with reference to FIG. 15, as part of the vehicle 1504 as described with reference to FIG. 15, etc. In some embodiments, the video analysis system can be configured to be implemented by a cloud computing system. The cloud computing system can include one or more controllers, servers, and/or any other computing devices that can be located remotely and/or connected to the systems of building 1500 via networks (e.g., the Internet). The cloud computing system can include any of the components or features of the cloud server 1616 shown in FIG. 16.

The video analysis system is shown to include a communications interface and a processing circuit. The communications interface may include wired or wireless interfaces (e.g., jacks, antennas, transmitters, receivers, transceivers, wire terminals, etc.) for conducting data communications with various systems, devices, or networks. For example, the communications interface may include an Ethernet card and port for sending and receiving data via an Ethernet-based communications network and/or a Wi-Fi transceiver for communicating via a wireless communications network. The communications interface may be configured to communicate via local area networks or wide area networks (e.g., the Internet, a building WAN, etc.) and may use a variety of communications protocols (e.g., BACnet, IP, LON, etc.).

The processing circuit is shown to include a processor and a memory. The processor can be implemented as a general-purpose processor, an ARM processor, an application specific integrated circuit (ASIC), one or more field programmable gate arrays (FPGAs), a group of processing components, or other suitable electronic processing components. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. The memory can be or include volatile memory and/or non-volatile memory. The memory can include object code components, script components, or any other type of information structure for supporting the various activities and information structures described in the present application. According to some embodiments, the memory is communicably connected to the processor via the processing circuit and can include computer code for executing (e.g., by the processing circuit and/or the processor) one or more processes of functionality described herein.

The video analysis system is shown to include a dataset manager configured to identify images, objects, or other items in the group of images/video provided by the cameras, image sources, and/or user devices into distinct categories based on subject matter. In some embodiments, the dataset manager is configured to categorize or label all images/video provided by the cameras, image sources, and/or user devices and/or categorize the video images based on labels included with the video/images. The dataset manager can be configured to generate a training dataset using all or a portion of the images/video from the cameras, image sources, and/or user devices.

The training dataset can be configured to contain images separated into object of interest annotations and foreign object annotations. For example, the images may be separated into the object of interest annotations and the foreign object annotations according to a specific enterprise within which the video analysis system is being implemented (e.g., in a shopping mall, in an airport, in a corporate center, etc.). Each object of the interest annotations can be configured as a finite group of known images or videos of objects that the video analysis system may be configured to identify. In the enterprise-specific example, the finite group of known images or videos of objects may include images or videos that capture objects known to the enterprise.

The object of interest annotations may include one or more images or videos derived from one or more cameras, image sources, and/or user devices. In some embodiments, the object of interest annotations further include a group of images/videos representing a variety of objects, shapes, features, and edges that form one or more objects of interest that the video analysis system can be configured to recognize. The one or more foreign object annotations can be a finite group of images/videos of objects which may partially occlude an image of the object of interest image annotations when analyzed by the video analysis system. In some embodiments, the one or more foreign object annotations are configured as a group of images/videos representing a variety of objects, shapes, features, and edges that form a foreign object or a group of foreign objects which may partially occlude one or more objects of interest contained within the object of interest annotations.

The training dataset is then provided as input to a model trainer which is used to train the model of the video analysis system to identify an object of interest or multiple objects of interest based on the images/videos of the object of interest annotation. The model trainer can also be configured to train the model of the video analysis system to remove foreign objects that might partially occlude an object of interest based on the images/videos of the foreign object annotation. Generally, the model trainer will produce a more accurate image/video annotation model if the training dataset includes many images with both the objects of interest annotations and the foreign object annotations.

The images of objects with the foreign annotations and the images of objects of interest that are divided into the object of interest annotations and the foreign object annotations can be images of different objects such that for a particular object, that particular object only occurs in one of the sets. In this regard, the dataset manager can be configured to cause the images of objects to be split up such that no images of the same object are in both sets. Examples of images of objects of interest and/or images of foreign objects include images of snow, rain, dust, dirt, windows, glass, cars, people, animals, a parking lot, a sidewalk, a building, a sign, a shelf, a door, a chair, a bicycle, a cup, a parking lot with snow, a parking lot with no snow, a parking space with snow, a parking space with no snow, a parking space with a car, a parking space with no car, and/or any other object.

In some embodiments, the model trainer can train the model to recognize various objects, actions, or other elements of interest in the images/video. Examples of actions include a person walking, a person running, a vehicle moving, a door opening or closing, a person digging, a person breaking a lock, fence, or other barrier, or any other action which may be relevant for the purposes of monitoring and responding to the images/videos provided by the cameras, image sources, and/or user devices. Recognizing actions can be based on still images from the cameras and image sources and/or videos provided by video cameras or other data sources. For example, the model trainer can receive a timeseries or set of video frames as an input and can recognize an action based on multiple video frames (e.g., a time segment or period of video data). Although cameras and image sources are described as the primary type of data sources used by the security system, it is contemplated that the same or similar analysis can be applied to other types of input data such as audio inputs from microphones, readings from motion sensors, door open/close data, or any other type of data received as input in a security system.

The model trainer can be configured to train the model using one or more training methodologies including gradient descent, back-propagation, transfer learning, max pooling, batch normalization, etc. For example, in some embodiments, the model trainer is configured to train the model from scratch, i.e., where the model has no prior training from some prior training data. In other embodiments, the model trainer is configured to train the model using a transfer learning process, wherein the model has previously been trained to accomplish a different set of tasks and is repurposed to identify and remove objects, features, shapes, and edges contained in the training dataset. In some embodiments, the model trainer can be configured to train the model using a feature extraction methodology.

The model can be any type of model suitable for recognizing objects, actions, or other entities in images or video. In some embodiments, the model can include one or more neural networks, including neural networks configured as generative models (e.g., generative AI models). For example, the model can predict or generate new data (e.g., artificial data; synthetic data; data not explicitly represented in data used for configuring the model). The model can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The model can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the model can include at least one GPT model. The GPT model can receive an input sequence and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token and selecting the next token according to the probability scores (e.g., selecting the candidate token having the highest probability scores as the next token). For example, the GPT model can apply various attention and/or transformer-based operations or networks to the modified input sequence to identify relationships between tokens for detecting the next token to form the output sequence.

The model can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the model includes a plurality of generative models, such as GPT and diffusion models, that can be trained separately or jointly to facilitate generating multi-modal outputs, such as technical documents (e.g., service guides) that include both text and image/video information.

In some implementations, the model can be configured using various unsupervised and/or supervised training operations. The model can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a video clip depicting an abnormality within a building or one or more images from a video clip, and a response representing data provided responsive to the abnormality depicted in the video/image data. The training data can include data that is not separated into input and output subsets (e.g., for configuring the model to perform clustering, classification, or other unsupervised ML operations). The training data can include human-labeled information, including but not limited to feedback regarding outputs of the models.

In some embodiments, the model may include a task-specific AI model and/or a general AI model which can be used in multiple domains. Non-limiting examples of AI models which could be used include GPT, BERT, DALL-E, and CLIP. Other examples include a CLIP4Clip model configured to perform video-text retrieval based on CLIP, an image-text model trained on image-text caption data (e.g., from an internet source), a video-text model trained on video-text caption data, or any other types of models configured to translate between text, images, videos, and other forms of input data (e.g., generate images based on user-specified text, find images that match user-specified text, generate or find video clips that match user-specified text, etc.).

In some embodiments, the model is a convolutional neural network including convolutional layers, pooling layers, and output layers. Furthermore, the model can include an activation subtractor. The activation subtractor can be configured to improve the accuracy of the model in instances where a foreign object partially occludes an object of interest. The activation subtractor improves the accuracy of the model by deactivating the activations of neurons associated with some foreign object and modifying the activations of neurons associated with objects of interest by subtracting the activation levels of all foreign objects from the activation levels of the objects of interest.

In some embodiments, the cameras and/or the image sources could be a security camera 1502 (as shown in FIG. 15) overlooking a parking lot and building 1500 (as shown in FIG. 15). The cameras and/or the image sources can also be configured to provide an image/video to the model implementer. The model implementer can cause the image/video annotation model including activation subtractor to operate using the image/video as input. The model and activation subtractor can be configured to deactivate the activation levels of the neuron activations caused by foreign object annotations. The model will operate and produce output in the form of an image/video annotation whereby the image/video is annotated by assigning a probability to image/video annotation.

The video analysis system is shown to include a natural language processor. In some embodiments, the natural language processor may include a chatbot configured to provide one or more responses to a user input. The chatbot can be configured to receive the user input in the form of a natural language input such as freeform text, spoken/verbal inputs, typewritten inputs, handwritten inputs, or other natural language inputs. The chatbot can be configured to extract relevant elements from the natural language inputs and may function as a natural language search system to allow a user to search the database of images/video using natural language search queries. For example, the chatbot may identify particular objects, persons, actions, or other entities indicated by the query from the user and may search the database of images/videos for the identified entities.

The chatbot can leverage the model to search the images/videos for the particular elements referenced in the natural language input. For example, a user could provide a search query such as “A person crossing over the fence or digging tunnel near the fence. Person is wearing red shirt and black bottom.” The chatbot may extract relevant elements from the search query (e.g., “person,” “fence,” “digging,” “tunnel,” “red shirt,” “black bottom,” etc.) and may search the images/videos for the extracted elements. The chatbot may use the model and/or interact with the model implementer to perform the search and output a response based on the results of the search. The response could include an indication of one or more images, videos, video clips, etc. that contain one or more of the elements extracted from the search query.

The response can be further provided as an input to a virtual agent where the response could cause some operation to be performed. For example, the virtual agent could utilize the response signal to automatically perform an operator function in response to the particular event, object, or action detected in the video data (e.g., “A person is attempting to break-in via the south entrance”). In some embodiments, the virtual agent may be configured to automate one or more actions on behalf of a human security officer. For example, in response to the particular event, object, or action detected in the video data, the virtual agent may be configured to automate generating an incident report, performing a risk analysis, dispatching first responder support, and/or activating one or more alarms. The virtual agent can be further configured to communicate with the user devices connecting the local network of the security camera with some external network. In some embodiments, the response could be used by the virtual agent to notify an external system or device (e.g., law enforcement, fire department, building security, etc.), through the user device, that a particular object, person, event, or other entity has been detected and that action should be taken in response.

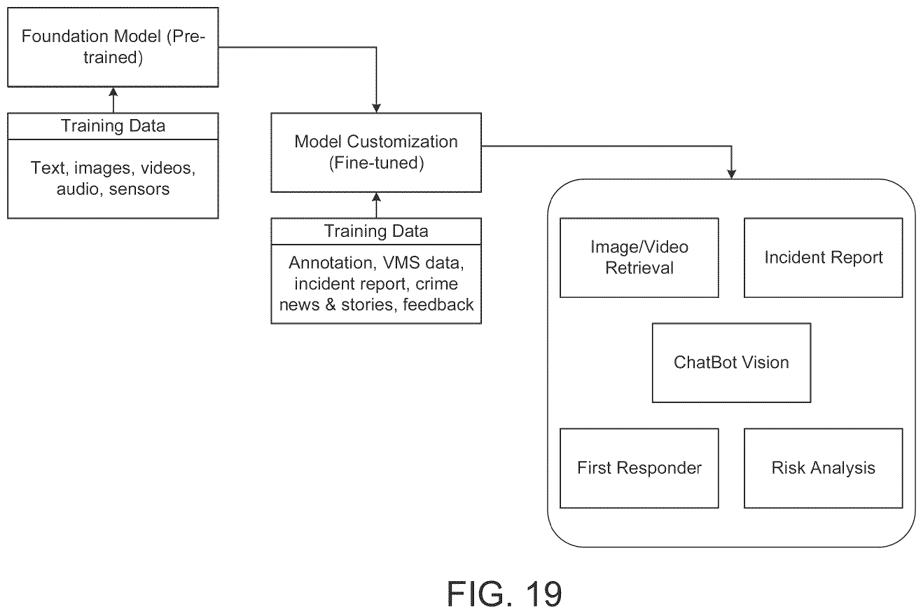

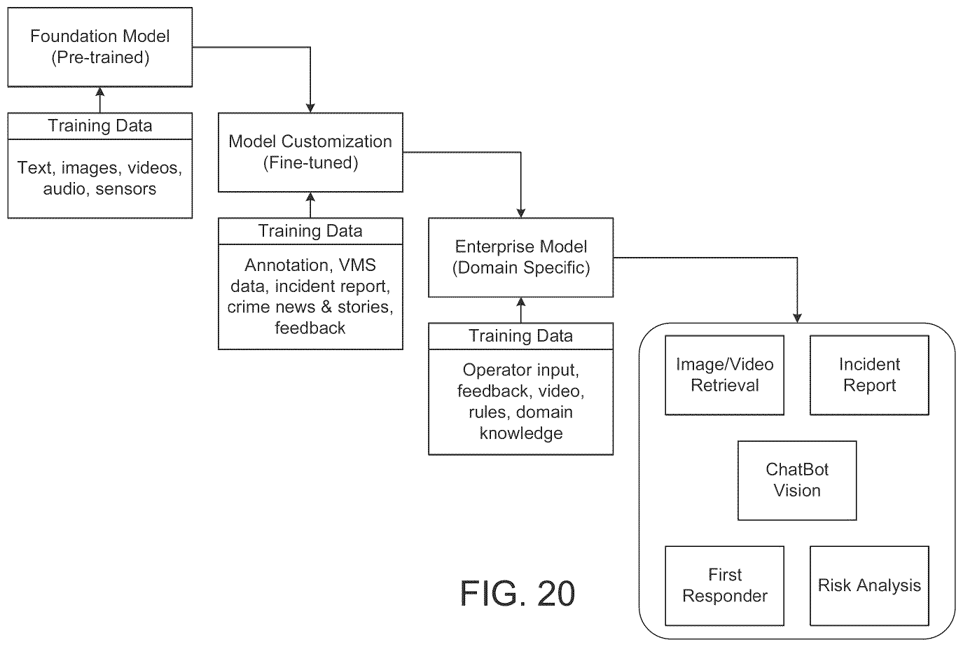

Referring now to FIGS. 19 and 20, example processes of using the security system of FIG. 18 to perform an operator function are shown, according to some embodiments. FIG. 19 illustrates a process in which an AI model (e.g., a foundation model) is trained using a first set of training data. In some embodiments, the first set of training data may include text captions, images, video footage, audio clips, and sensor data. The trained AI model is then fine-tuned according to a second set of training data. In some embodiments, the second set of training data may include annotations to the first set of training data, video management system (VMS) data, incident reports, crime reports (e.g., news stories, etc.), and feedback. The fine-tuned model may then be used to retrieve one or more relevant images and/or video segments, generate an incident report, implement a chatbot function, dispatch first responder support, or perform a risk analysis. FIG. 20 illustrates additional steps to the process shown in FIG. 19 for training a domain-specific enterprise model. For example, after the model is fine-tuned, the enterprise model may be further trained according to a third set of training data. The third set of training data refers to domain-specific training data. For example, the third set of training data may include at least one of operator input, feedback, video footage, rules, or domain knowledge associated with a specific enterprise. After receiving the domain-specific training, the enterprise model may be configured to perform an operator function related to the particular enterprise (e.g., image/video retrieval, generating incident reports, implementing a chatbot, dispatching first responder support, performing a risk analysis, etc.).

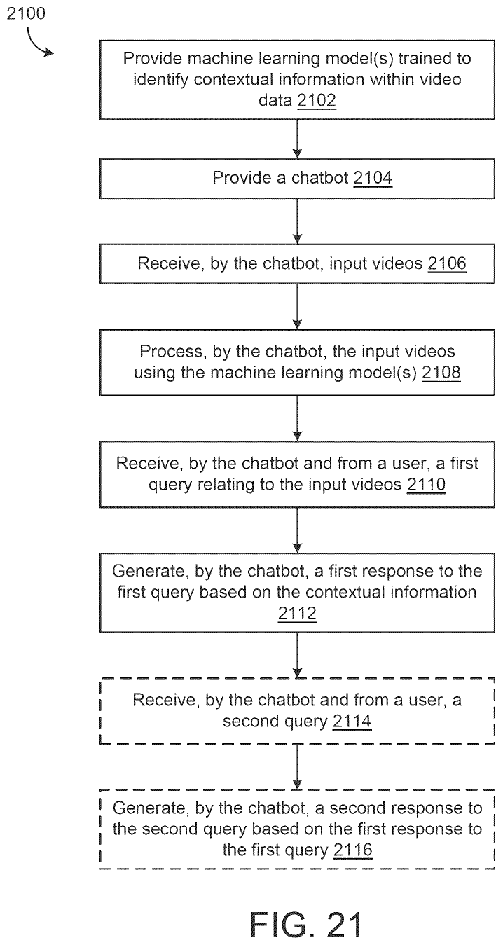

Referring now to FIG. 21, a flowchart of a process 2100 for providing a chatbot in a building security system is shown, according to an exemplary embodiment. In some embodiments, process 2100 may be performed by the video analysis system of FIG. 18 using the model described with reference thereto. In some embodiments, the model used in process 2100 is a machine learning model and may be the same as or similar to the model shown in FIG. 18. For example, the machine learning model may include a foundation AI model. Foundation AI models or general-purpose AI (GPAI) models are capable of a range of general tasks such as text synthesis, image manipulation and generation, and audio generation. Examples of foundation AI models include the GPT-3 and GPT-4 models used in the conversational chat agent ChatGPT. Some foundation AI models are capable of taking inputs in a single modality (e.g., text) whereas other foundation AI models others are multimodal and are capable taking multiple modalities of input (e.g., text, image, video, etc.) and generating multiple types of output (e.g., generating images, summarizing text, answering questions) based on those inputs.

Process 2100 is shown to include providing a machine learning model trained to identify contextual information within video data (step 2102). The contextual information within the video data refers to objects, people, environment, and so on, depicted in videos/images captured by a camera (e.g., security camera 1502). The machine learning model may be capable of accepting inputs in a single modality (e.g., text, audio, video, etc.) or multiple modalities simultaneously. The machine learning model may include a generative AI (GAI) model, a large language model (LLM), and/or other type of AI model.

In some embodiments, the machine learning model is a GAI model capable of generating content in one or more modalities (e.g., text, audio, video, etc.) based on user inputs such as text prompts (e.g., a search query). In some embodiments, the machine learning model is a LLM capable of generating natural language responses to inputs or prompts. A LLM can, in some cases, be trained on text prediction tasks and may be capable of predicting the likelihood of a character, word or string, based on the preceding or surrounding context. For example, LLMs can predict the next most likely word in a sentence given the previous paragraph. In this way, a LLM may be used to pre-populate a search query and/or a portion of a search query from a user based on one or more previous interactions between the user and the machine learning model (e.g., a chatbot).

Although not specifically shown in FIG. 21, step 2102 may include training the machine learning model using a set of training data such as video files, images, text data, and corresponding annotations. The machine learning model can be trained to recognize a variety of objects, persons, events, and other elements within the video content of a video file (e.g., within the image data as opposed to the metadata). For example, the machine learning model can recognize the shape of a person, can distinguish an adult from a child, and can recognize other objects such as vehicles, strollers, escalators, or any other type of object or person. The machine learning model can be trained to recognize various actions or events depicted in a video file. For example, the machine learning model can be trained to recognize a person walking, a person running, a person or machine digging a hole, a person playing with a child, a car parking, weather conditions such as rain, snow, or wind, or other events that play out over multiple frames of the video file. In some embodiments, the machine learning model is trained on a large volume of video data collected from cameras or other video sources in a building security system and/or other video data gathered from other sources.

In some embodiments, step 2102 includes training the machine learning model with a large data set of image and text pairs (e.g., 400 million). Step 2102 may further include refining or fine-tuning the machine learning model with a refined data set (e.g., 1500,000) of images, videos, and corresponding text captions. In other embodiments, the machine learning model may be pre-trained and ready for use without requiring training as part of process 2100. For example, the machine learning model may be pre-trained to detect or identify a variety of different objects, persons, and/or events/activities without requiring extensive training as part of process 2100.

Process 2100 is shown to include providing a chatbot (step 2104). The chatbot may be the natural language processor of the video analysis system of FIG. 18, as described above. The chatbot uses the model of FIG. 18 to facilitate a conversational back-and-forth between a user and the video analysis system. For example, the chatbot may be trained, using the trained machine learning model, to answer user queries relating to video/image data captured by a camera within a security system (e.g., security camera 1502). In some embodiments, the chatbot may be provided with one or more functionalities according to a role and/or permissions of the user accessing the chatbot. For example, some users may not have access to video/image data from the security cameras 1502. In another instance, the user may be prompted (e.g., by the chatbot) to input a credential (e.g., a biometric scan, a personnel ID, a password, etc.) before receiving the video/image data from the chatbot in response to the query submitted by the user.

Process 2100 is shown to include receiving, by the chatbot, input videos (step 2106). The input videos may include videos from the security cameras 1502. In some embodiments, the input videos may depict a person, an object, building activity, and so on. The input videos may include real-time video footage (e.g., a live stream, a live feed, etc.) received from the security camera 1502 and recordings of previous video footage captured by the security cameras 1502. In some embodiments, the recordings may be stored in a memory of the video analysis system of FIG. 18.

Process 2100 is shown to include processing the input videos using the machine learning model (step 2108). Step 2108 may include using the trained machine learning model to process video files obtained from video cameras or other image sources in a building system that have been annotated (e.g., during training of the machine learning model) according to the persons, objects, and events depicted in the video files. In some embodiments, step 2108 includes tagging the video files or portions thereof (e.g., time ranges within the video file) with semantic tags that indicate the annotations assigned to each video file or time segment. Examples of tags that can be assigned to various video files include tags denoting various types of objects or persons detected in the video files (e.g., vehicle, fence, stroller, person, security person, maintenance person, etc.), characteristics or qualities of the detected objects or persons (e.g., red shirt, black pants, hat, tall, short, male/female, delivery truck, passenger vehicle, vehicle (car), etc.), events or activities depicted in the video files (e.g., person running, vehicle moving, vehicle parking, vehicle collision, snow falling, child playing, etc.).

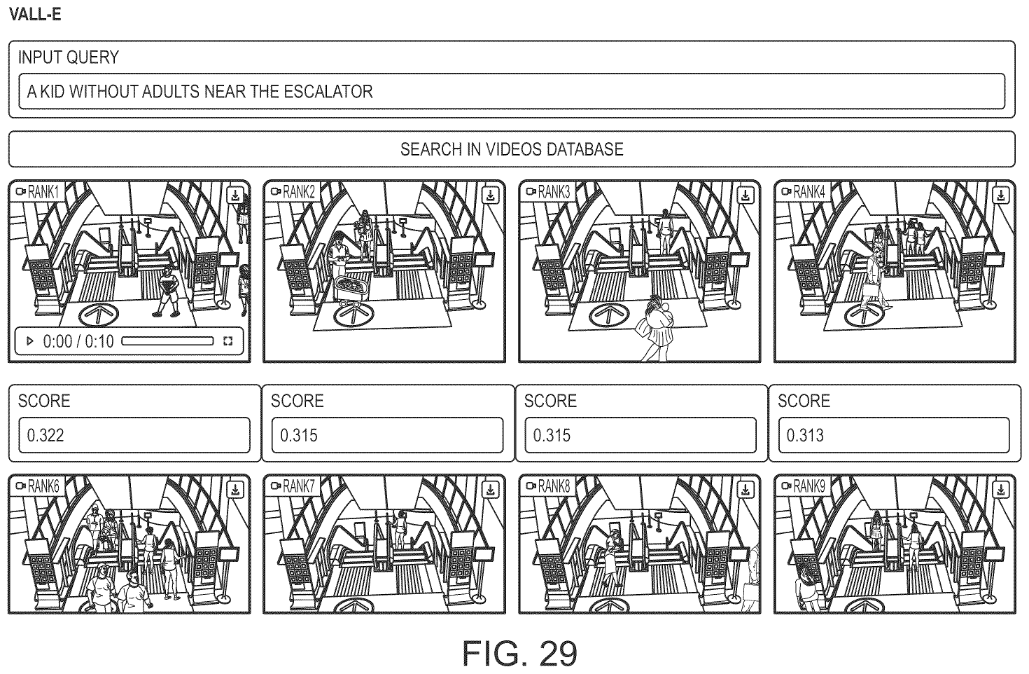

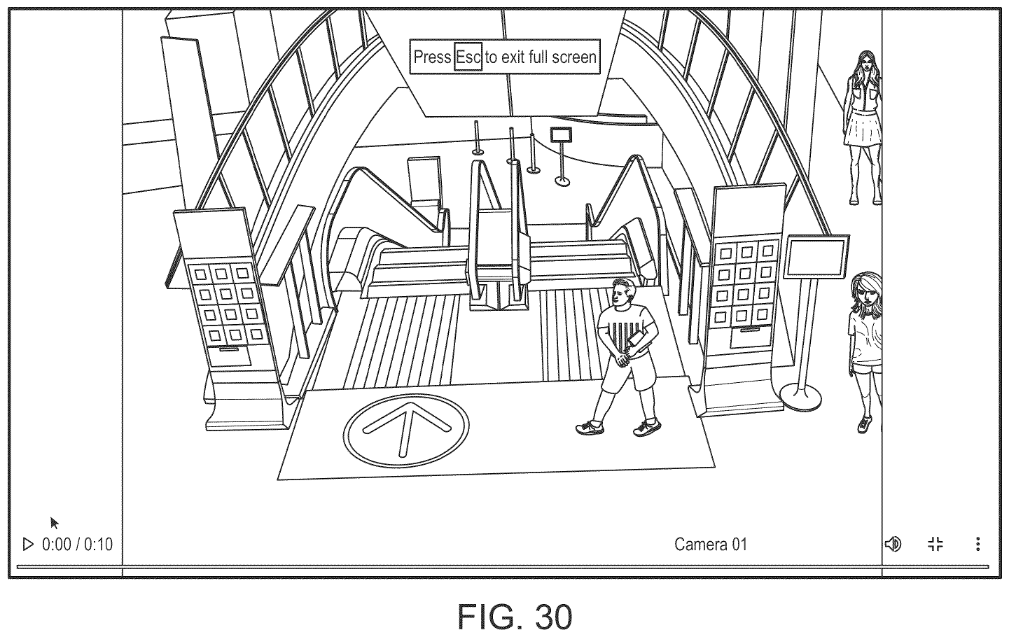

In various embodiments, the tags can be assigned to the video files as a whole (e.g., as metadata or otherwise linked to the video files) or to particular segments of the video files. In some embodiments, the video files are broken down into multiple time segments of any duration (e.g., 1 second, 10 seconds, 30 seconds, 1 minute, 10 minutes, 1 hour, etc.) and each segment is assigned a plurality of tags according to the particular types of persons, objects, events, activities, or other entities detected in the segment by the machine learning model. The tagged video files may be stored in a database accessible to the building system and/or security system. In some embodiments, the tags are used to index the video files and/or the segments of the video files and can be used to retrieve relevant video files/segments in response to a search query (e.g., as described below with reference to FIGS. 29-30).

Process 2100 is shown to include receiving a first query from a user relating to the input videos (step 2110). The first query may be a natural language search query. In some embodiments, the user may submit the first query to the chatbot via a user interface of a user device (e.g., via the user interface illustrated in FIG. 29). The first query can be entered via a text box of a graphical user interface (e.g., as freeform text), received via a microphone or other user interface device configured to capture audio data, converted from handwriting, drawings, or other freeform inputs or otherwise received in any modality of input.

Process 2100 is shown to include generating a first response to the first query based on the contextual information identified in the input videos by the machine learning model (step 2112). Step 2112 may include searching the tags or other annotations assigned to the video files/segments in step 2108 to identify particular video files or segments that are relevant to the extracted intent and entities. In some embodiments, step 2112 includes assigning a relevancy score to each video file or segment based on how well the video file or segment matches the intent and entities. The relevant video files and segments (e.g., having a relevancy score above a threshold, having the highest relevancy scores, etc.) may be selected as results of the search and presented to the user via the user interface (e.g., the user interface depicted in FIGS. 29-30, as described below). In some embodiments, the user interface allows each video file or segment to be played directly from the user interface and/or may include supplemental annotations marking the locations of particular objects, persons, events, or other entities.

In some embodiments, process 2100 may include receiving a second query from the user (step 2114). For example, the machine learning model can be configured to engage in natural language conversation with a user via the user interface (e.g., functioning as a chatbot) and ask the user questions to help refine the search query and the set of search results. In this way, the user can provide more specific input and the machine learning model can assist the user in providing additional information to return more relevant, additional, or specific search results. As another example, the initial set of search results may include a video file that depicts a particular person of interest (e.g., a suspected trespasser, a particular employee, etc.). Upon selecting or viewing the initial search results or video file, the user may ask the machine learning model to “show me all videos or images with this person” and the machine learning model may run an updated search to find other videos and/or images depicting the same person.

After receiving the second query from the user in step 2114, process 2100 may include generating a second response to the second query (step 2116), where the second response may be generated based on the first response to the first query. For example, the second response may include a subset of videos and/or images from among the videos and/or images presented to the user in the first response to the first query. As another example, the second response may include a set of videos and/or images depicting a same person, object, or event depicted in the first response to the first query, but from a different camera (e.g., another security camera 1502). The different camera may provide a new perspective of the person, objected, or event depicted in the videos and/or images included in the first response to the first query. In some embodiments, step 2114 and step 2116 of process 2100 may be performed as an iterative process for facilitating the conversational back-and-forth between the user and the chatbot. In this way, the chatbot may receive a plurality of queries from the user and may generate responses to the plurality of queries based on responses to previous queries received during the iterative process.

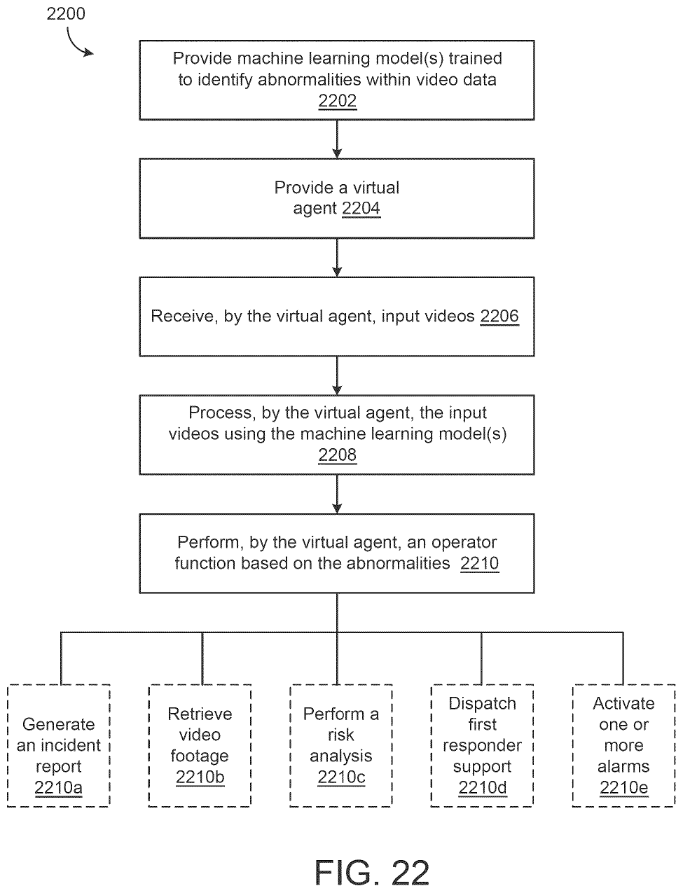

Referring now to FIG. 22, a flowchart of a process 2200 for providing a virtual agent in a building security system is shown, according to an exemplary embodiment. In some embodiments, process 2200 may be performed by the video analysis system of FIG. 18 using the model described with reference thereto. In some embodiments, the model used in process 2200 is a machine learning model and may be the same as or similar to the model shown in FIG. 18.

Process 2200 is shown to include providing a machine learning model trained to identify abnormalities within video data (step 2202). The abnormalities within the video data refer to objects, persons, events, and other elements depicted in videos/images captured by a camera (e.g., security camera 1502) that are outside of the objects, persons, events, and other elements that are normally captured by the security camera 1502. That is, the machine learning model may be trained using videos/images from the security camera 1502 so that the machine learning model may distinguish between the objects, persons, events, and other elements that are normally captured by the security camera 1502 and abnormalities.

Although not specifically shown in FIG. 22, step 2202 may include training the machine learning model using a set of training data such as video files, images, text data, and corresponding annotations. The machine learning model can be trained to recognize a variety of objects, persons, events, and other elements within the video content of a video file (e.g., within the image data as opposed to the metadata). For example, the machine learning model can recognize the shape of a person, can distinguish an adult from a child, and can recognize other objects such as vehicles, strollers, escalators, or any other type of object or person. The machine learning model can be trained to recognize various actions or events depicted in a video file. For example, the machine learning model can be trained to recognize a person walking, a person running, a person or machine digging a hole, a person playing with a child, a car parking, weather conditions such as rain, snow, or wind, or other events that play out over multiple frames of the video file. In some embodiments, the machine learning model is trained on a large volume of video data collected from cameras or other video sources in a building security system and/or other video data gathered from other sources.

In some embodiments, step 2202 includes training the machine learning model with a large data set of image and text pairs (e.g., 400 million). Step 2202 may further include refining or fine-tuning the machine learning model with a refined data set (e.g., 1500,000) of images, videos, and corresponding text captions. The refined data set may include images, videos, and corresponding text captions associated with a particular enterprise (e.g., a shopping mall, an airport, a corporate center, etc.), such that the machine learning model may be trained to identify abnormalities unique to the particular enterprise. For example, an abnormality in one enterprise (e.g., a group of persons with suitcases in a shopping mall) may not be an abnormality in one or more other enterprises (e.g., a group of persons with suitcases in an airport). In other embodiments, the machine learning model may be pre-trained and ready for use without requiring training as part of process 2200. For example, the machine learning model may be pre-trained to detect or identify a variety of different objects, persons, and events/activities suggesting abnormal behavior without requiring extensive training as part of process 2200.

Process 2200 is shown to include providing a virtual agent (step 2204). The virtual agent may be the virtual agent of the video analysis system of FIG. 18, as described above. The virtual agent uses the model of FIG. 18 to automatically perform one or more operator functions in response to the machine learning model detecting one or more abnormalities identified by the machine learning model among video data. For example, the virtual agent may be trained, using the trained machine learning model, to automatically perform an operator function relating to video/image data captured by a camera within a security system (e.g., security camera 1502). In some embodiments, a user may be prompted (e.g., by the virtual agent) to input a credential (e.g., a biometric scan, a personnel ID, a password, etc.) before the virtual agent is authorized to perform the operator function. For example, a building lockdown (e.g., prohibiting entry/exit through any doors in a facility, broadcasting a lockdown message, etc.) may require approval from authorized personnel (e.g., a security officer, a police officer, a company executive, etc.) before the virtual agent automatically performs the building lockdown. In some embodiments, a request for approval may be transmitted via a communication (e.g., an email, a text message, a phone call, a push notification, etc.) to the authorized personnel such that the authorized personnel may approve the request from a remote location.

Process 2200 is shown to include receiving, by the virtual agent, input videos (step 2206). The input videos may include videos from the security cameras 1502. In some embodiments, the input videos may depict a person, an object, building activity, and so on, representing one or more abnormalities. The input videos may include real-time video footage (e.g., a live stream, a live feed, etc.) received from the security camera 1502 and recordings of previous video footage captured by the security cameras 1502. In some embodiments, the recordings may be stored in a memory of the video analysis system of FIG. 18.

Process 2200 is shown to include processing the input videos using the machine learning model (step 2208). Step 2208 may include using the trained machine learning model to process video files obtained from video cameras or other image sources in a building system that have been annotated (e.g., during training of the machine learning model) according to the persons, objects, and events depicted in the video files. In some embodiments, step 2208 includes tagging the video files or portions thereof (e.g., time ranges within the video file) with semantic tags that indicate the annotations assigned to each video file or time segment. Examples of tags that can be assigned to various video files include tags denoting various types of objects or persons detected in the video files (e.g., vehicle, fence, stroller, person, security person, maintenance person, etc.), characteristics or qualities of the detected objects or persons (e.g., red shirt, black pants, hat, tall, short, male/female, delivery truck, passenger vehicle, vehicle (car), etc.), events or activities depicted in the video files (e.g., person running, vehicle moving, vehicle parking, vehicle collision, snow falling, child playing, etc.).

In various embodiments, the tags can be assigned to the video files as a whole (e.g., as metadata or otherwise linked to the video files) or to particular segments of the video files. In some embodiments, the video files are broken down into multiple time segments of any duration (e.g., 1 second, 10 seconds, 30 seconds, 1 minute, 10 minutes, 1 hour, etc.) and each segment is assigned a plurality of tags according to the particular types of persons, objects, events, activities, or other entities detected in the segment by the machine learning model. The tagged video files may be stored in a database accessible to the building system and/or security system. In some embodiments, the tags are used to index the video files and/or the segments of the video files and can be used to retrieve relevant video files/segments in response to detecting one or more abnormalities, as described below with reference to step 2210b.

Process 2200 is shown to include performing, by the virtual agent, an operator function based on one or more abnormalities detected by the machine learning model (step 2210). The operator function may include any task, operation, act, and so on, included among the responsibilities of a security operator. That is, where a security operator performs a particular action in response to detecting abnormal behavior, the virtual agent is trained to perform the particular action on behalf of the security operator. In some embodiments, the virtual agent may be communicatively coupled to one or more subsystems of the security system 1600 (e.g., the building subsystems 1604, the fire safety subsystems 1606, the security subsystems 1608, etc.) via the cloud server 1616. In this way, the virtual agent may be configured to perform the operator function with respect to a specific area of the building 1500 where the abnormality has been detected. Communication with these subsystems may also, in some embodiments, prompt the virtual agent to perform the operator function in response to sensor data (e.g., security sensors, smoke sensors, carbon monoxide sensors, door sensors, motion sensors, etc.) as well as in response to video data. As described below, the operator function may include generating an incident report (step 2210a), retrieving video footage (step 2210b), performing a risk analysis (step 2210c), dispatching first responder support (step 2210d), and/or activating one or more alarms (step 2210e). In some embodiments, each of these operator functions may be performed individually. Alternatively or additionally, multiple of the operator functions may be performed concurrently.

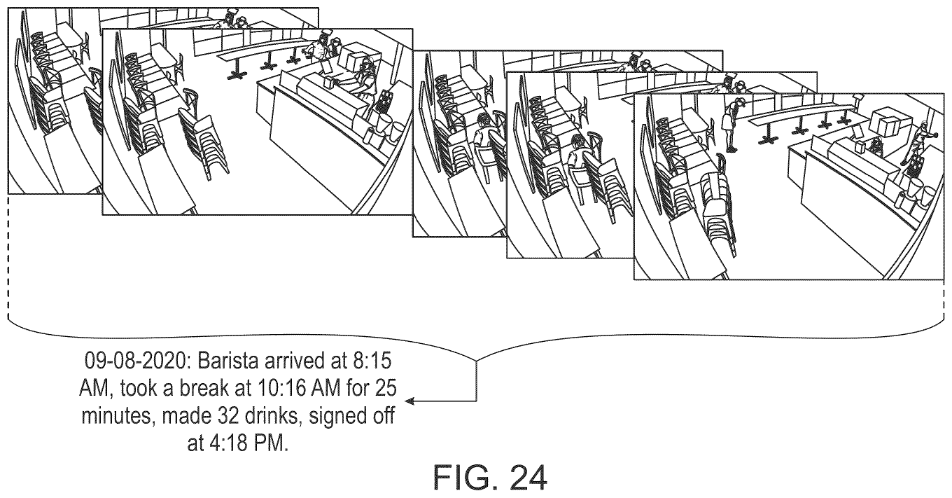

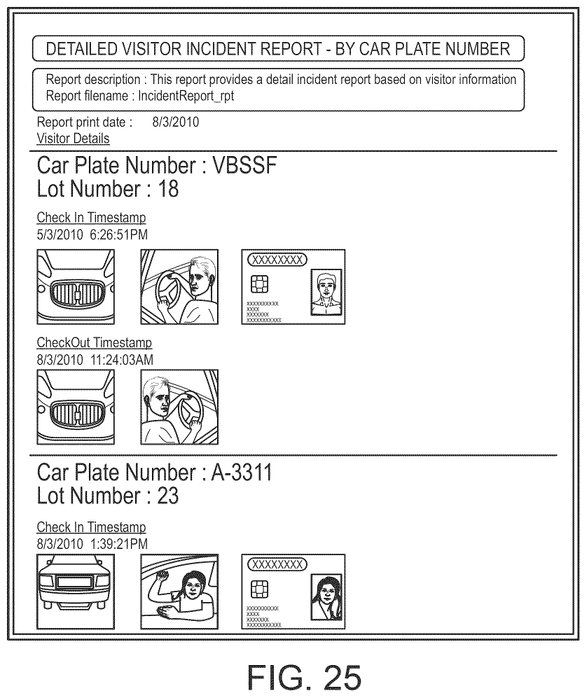

As shown in FIG. 22, the operator function performed by the virtual agent may include generating an incident report (step 2210a). In some embodiments, the incident report generated by the virtual agent may include the incident report illustrated in FIG. 25. The incident report may include information relating to an abnormality detected by the machine learning model from the input videos received from the security cameras 1502. For example, the incident report may include a text summary and images/video clips from one or more relevant input videos depicting the abnormality. In some embodiments, the virtual agent may automatically generate the incident report from a text summary generated by the model of FIG. 18 (e.g., as described with reference to FIG. 24) by combining the text summary with significant images/videos (e.g., persons of interest, damages, etc.). A security team (e.g., human security officer(s)) can create an incident report including still image capture, original video clips, and textual summaries describing what happened, but an automatically created incident storyboard may be more efficient when responding to an abnormality (e.g., by automatically generating relevant context as opposed to leaving it to the security team to glean the context from the raw data). In some example implementations, this incident report can be automatically sent to users who may have additional information to fill in (for example, identifying names). In some example implementations, the incident report generated by the virtual agent may be automatically provided (e.g., via an email message, a text message, a push notification, etc.) to relevant personnel (e.g., the security team, first responders, one or more executives/managers associated with the enterprise, etc.).

As shown in FIG. 22, the operator function performed by the virtual agent may include retrieving video footage (step 2210b). In some embodiments, the video footage may include a live video feed from a security camera 1502, one or more static images from the security cameras 1502, and/or one or more video recordings. The one or more static images and video recordings may be stored in the video analysis system of FIG. 18. The virtual agent may be configured to retrieve relevant video footage by first identifying one or more security cameras 1502 in close proximity to a location of the detected abnormality. From the identified security cameras 1502, the virtual agent may connect to a live stream of video data from the cameras to verify whether the abnormality is depicted in the live stream. Additionally or alternatively, the virtual agent may identify images/videos stored in the video analysis system and associated with the identified security cameras 1502 that depict the abnormality. For example, the machine learning model may detect an unauthorized person entering a building of a corporate center, and the virtual agent may retrieve relevant video files/segments including one or more tags also associated with the unauthorized person (e.g., a physical description of the person, one or more objects on/with the person, a direction of travel of the person, etc.). The retrieved video footage may be sent to relevant personnel (e.g., a human security operator, an executive associated with the enterprise, one or more first responders, etc.) for viewing (e.g., via a graphical user interface).

As shown in FIG. 22, the operator function performed by the virtual agent may include performing a risk analysis (step 2210c). The risk analysis may be performed by the virtual agent with respect to an abnormal event/situation detected among the input videos by the machine learning model. In some embodiments, the risk analysis may be influenced by user feedback. For example, interaction between the user (e.g., a human security officer) and the system, such as receiving user feedback, can collect the user's evaluation of the level of risk for certain activities/events. In some embodiments, the virtual agent may perform the risk assessment based on contextual information provided by video data and/or sensor data from the security system 1600. For example, if the detected abnormality includes a person running, the virtual agent may receive additional video data from the security system 1600 depicting a fire and sensor data from a smoke sensor of the fire safety subsystems 1606. Based on the contextual information revealing the fire, the virtual agent may generate a higher risk assessment of the abnormality than in the absence of the contextual information. The risk assessment may include a numerical score, a categorical score, or any other report indicating the assessed risk associated with the abnormality.

As shown in FIG. 22, the operator function performed by the virtual agent may include dispatching first responder support (step 2210d). For example, paramedic support may be provided in response to a crowd gathering around an injured individual, police or tactical support may be provided in response to a sudden crowd dispersion due to an individual revealing a weapon, firefighters may be deployed in response to crowd dispersion due to an accident involving a fire, etc. As another example, the virtual agent may dispatch first responder support for general flow management as a preventative action when large crowds suddenly gather in areas (due to events such as school outings or road closures, for example). The virtual agent may also dispatch first responder support in response to third-party data (e.g., social media posts, news reports, etc.) indicating one or more security threats to the building 1500.

As shown in FIG. 22, the operator function performed by the virtual agent may include activating one or more alarms (step 2210e). The one or more alarms may include any alarms associated with the security system 1600 (e.g., smoke alarms, carbon monoxide alarms, door alarms, burglar alarms, etc.). For example, a video input may reveal an unauthorized person approaching a restricted area of the building 1500. The virtual agent, in response, may activate a burglar alarm. In some embodiments, the one or more alarms may include a public announcement broadcast over a speaker. For example, if the video input reveals a lost child wandering alone in an airport, the virtual agent may activate a public announcement throughout at least a portion of the airport announcing the missing child.

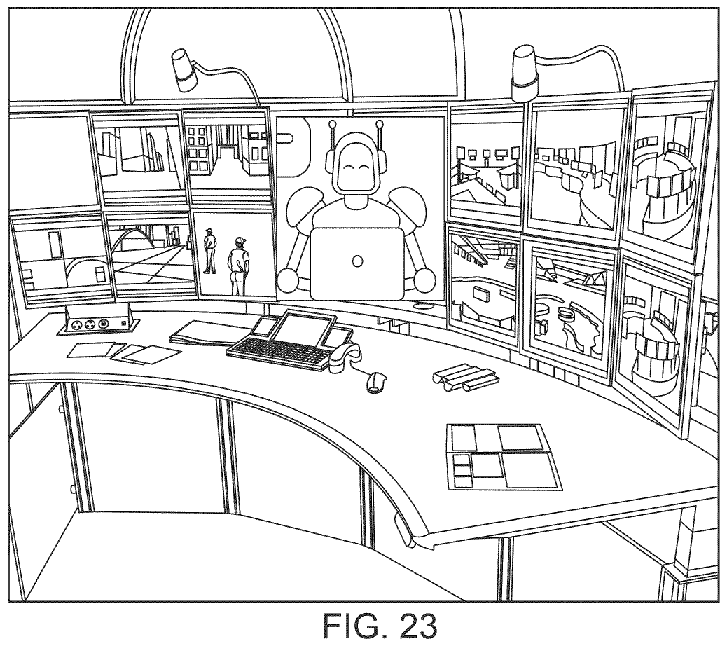

FIGS. 23-28 illustrate various features and implementations of the video analysis system described herein. FIG. 23 depicts an example of a security operations center (SOC) of a building security system (e.g., the building security system of FIG. 16). The SOC may be an area of the building where a human security officer typically works/performs operator functions (e.g., generates an incident report, retrieves video footage, performs a risk analysis, dispatches first responder support, activates one or more alarms, and so on). As shown in FIG. 23, the SOC may include a plurality of monitors configured to stream live video footage from one or more security cameras 1502 throughout the building security system. FIG. 23 illustrates a virtual agent to demonstrate that the operator functions performed by a human security officer in the SOC may be alternatively performed by a virtual agent, as described herein.

FIG. 24 illustrates an example of a text summary of a surveillance video generated by the model of FIG. 18, according to some embodiments. The text summary may be generated depending on one or more of a variety of different factors, such as a user/recipient's role, position, and/or responsibilities (e.g., Executive-, Director-, and Operator-level details). For example, a machine learning model (e.g., the model included in the video analysis system of FIG. 18) may generate, based on a particular video input or set of video inputs, a first summary for an executive-level user and a different second summary for an operator-level user. In various implementations, the summaries may differ based on the type of content, the amount of content, a timeframe to which the summary corresponds, a frequency of generating the summary (e.g., more frequent summaries for a lower-level role), etc.

While role is one example factor for generating the text summaries, the summaries could be generated based in part on a variety of other factors, including, but not limited to, location, individuals present at the location, events (e.g., events occurring at the location), and/or various other factors. In some embodiments, the machine learning model may output a short summary of one or more input videos and/or images. In some embodiments, a foundation model or other type of model can be used to combine a plurality of summaries (e.g., many small summaries). In some embodiments, the video can be analyzed with object detection or motion detection to omit irrelevant or motionless video footage from being sent to the model (e.g., using a smart camera with an AI model to run the analysis). In various embodiments, a variety of different factors and/or image processing techniques may be utilized to determine portions of input videos/images that are more or less relevant than other portions, and “relevance” may differ depending on the intended use case (e.g., movement may be most relevant for one use case but not for another use case). In some embodiments, the system can use a push model to send push notifications with the summaries through SMS, email, app notifications, and/or some other method. The summaries can also be sent at different frequencies depending on the user (e.g., user role, user preferences, etc.).

In some implementations, the text summary can relate to any user-specified duration of video footage. For example, when the user initiates a query to receive a summary (e.g., via the chatbot provided during process 2100), they may define a window of time for the summary to cover. An LLM or other type of machine learning or AI model can be used to combine text description outputs from multiple videos into a narrative summary. The LLM can create context that can be fed into a bank of queries from the users and/or into a CLIP query. Additionally, or alternatively, textual output from a multi-modal model such as CLIP can be fed into an LLM configured to generate a combined narrative summary from the output. In various examples, the model may perform basic concatenation of the individual textual descriptions to form the full description or may perform more complex processing, such as generating a unique, new textual description of multiple video and/or image inputs. The results from the LLM can be grouped over a window of time, and the textual descriptions from the group can be used to create the narrative summary received by the user. For example, if a user requests a day summary for a particular worker or other individual on the site, the narrative summary may include time and/or other circumstances of the worker's arrival to site, time spent on site, time seen actively working versus taking breaks, any unusual actions or activities outside the norm of what would be expected for the worker's role, time of departure from site, etc. According to some embodiments, the present disclosure creates unique use cases of the summaries of videos by weaving them together into a more useful deliverable to the user.

In some embodiments, the text summary can be used in summary-to-summary comparisons, such as to generate a risk analysis. The risk analysis may be an operator function performable by the virtual agent of the video analysis system of FIG. 18. Interaction between the user and the system, such as receiving user feedback, can collect the user's evaluation of the level of risk for certain activities. A risk notification can be sent to a user based on the video to text analysis. Context from the video (for example, was an employee in the building alone, was there detection of a fire, was there an indoor air quality alert, etc.) can be provided to identify one or more users to receive the notification. For example, one context may cause the system to generate an alert for a single user designated to address a particular issue associated with the context. Another context may cause the system to send alerts to multiple users, such as a security officer and a facility manager and/or a person to whom there may be a risk in view of the context. In this context, the alerts to the multiple users may be sent either as simultaneous alerts, cascading alerts (e.g., such that an alert is sent to a second recipient if a first recipient does not acknowledge an alert or take action in a particular timeframe), or in some other manner. An alert can activate another specific model, such as wide area tracking or re-identification. By activating another specific model, the alerts may cause the virtual agent to automatically perform one or more additional operator functions (e.g., initiating the wide area tracking and/or the re-identification). For example, if the video analysis detects a child alone in the building, the associated alert can activate a wide area tracking model to know where to send security. This risk scoring process can automatically assess the risk level from the text description (e.g., text summaries) of the videos and determine whether immediate action is required based on that assessment. In some implementations, the models may generate actual scores evaluating a severity and/or location impact of the risk event, such as a numerical score or other relative risk score.

FIG. 25 illustrates an example of an incident report generated by the model of FIG. 18, according to some embodiments. In some embodiments, a text summary generated by the model of FIG. 18 (e.g., as described with reference to FIG. 24) can be used to automatically create an incident report by combining the text summary with significant images/videos (e.g., persons of interest, damages, etc.). A security team (e.g., human security officer(s)) can create an incident report including still image capture, original video clips, and textual summaries describing what happened, but an automatically created incident storyboard may be more efficient when responding to an abnormality (e.g., by automatically generating relevant context as opposed to leaving it to the security team to glean the context from the raw data). The virtual agent, as described herein, may be configured to automatically generate an incident report in response to an abnormality detected among the video/image data. In some example implementations, this incident report can be automatically sent to users who may have additional information to fill in (for example, identifying names). In some example implementations, the incident report generated by the virtual agent may be automatically provided (e.g., via an email message, a text message, a push notification, etc.) to relevant personnel (e.g., the security team, first responders, one or more executives/managers associated with the enterprise, etc.).

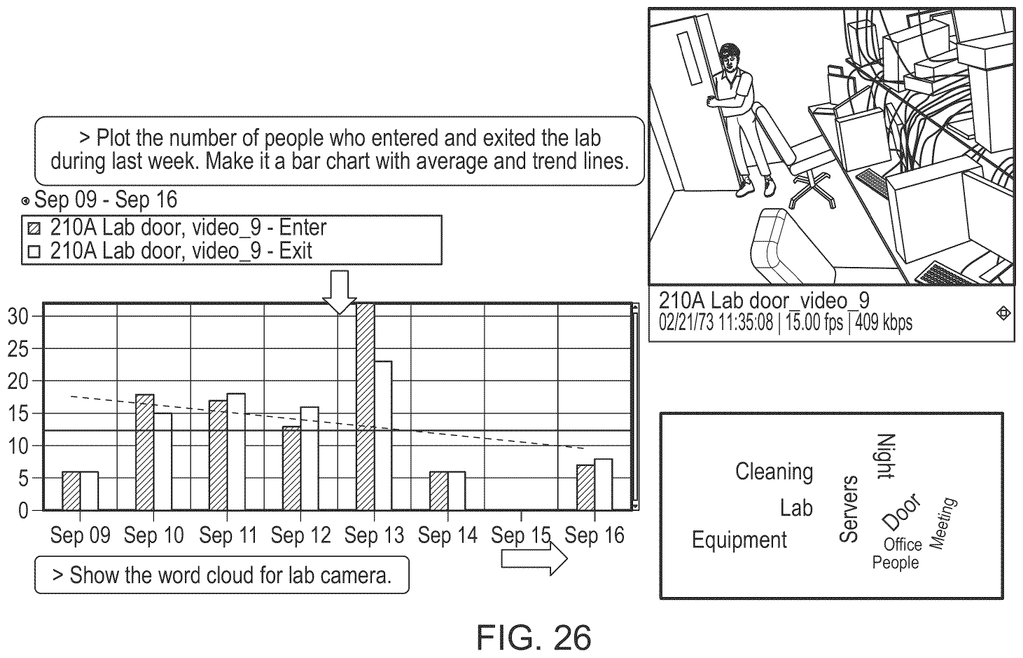

FIG. 26 illustrates an example of statistics derived from video data by the model of FIG. 18, according to some embodiments. In some embodiments, the statistics may include one or more graphs, charts, tables, or other graphics depicting information revealed from the video data. As shown in FIG. 26, the statistics may include a bar chart depicting a number of people who have entered and exited an area of the building per day over a specific time frame. The bar chart may further include average and trend lines, in addition to the number of people per day. As another example, the statistics may include a word cloud associated with the video data. The word cloud may include a plurality of words associated with objects, persons, activities, surroundings, and so on, depicted in the video data. The word cloud may be generated based on the textual description of the video data, as described with reference to FIG. 24. The word cloud may be generated such that the most relevant terms (e.g., occurring most frequently in the textual description, most accurately depicting what is seen in the video data, most specific to the video data, etc.) are printer in a larger text than the terms that are less relevant to the video data.

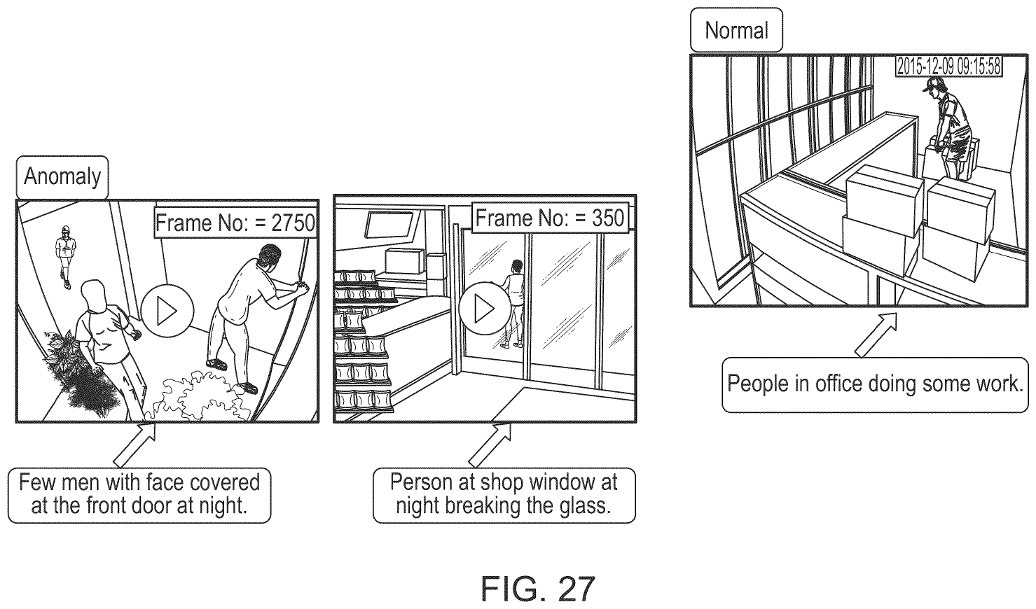

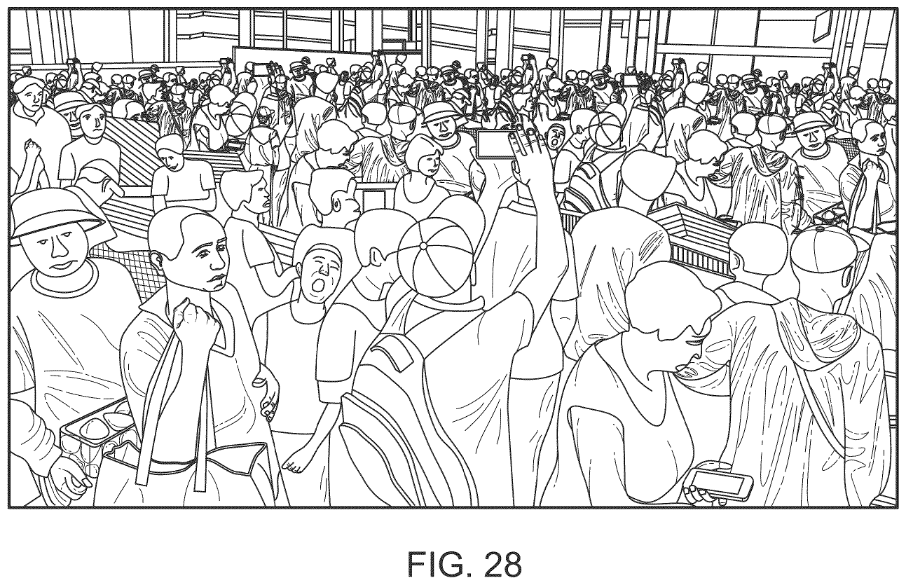

FIG. 27 illustrates an example of annotated video data and/or image data used to detect anomalous activity using the model of FIG. 18, according to some embodiments. As shown in FIG. 27, the annotated video data and/or image data may include video footage and/or static images that are flagged as depicting an anomaly. The video footage and/or static images may be accompanied by a textual summary of what is shown (e.g., “few men with face covered at the front door at night,” “person at shop window at night breaking the glass”). The annotated video data and/or image data may further include video footage and/or static images that are flagged as depicting normal activity. The video footage and/or static images depicting normal activity may also be accompanied by the textual summary of what is shown (e.g., “people in office doing some work”). By training the machine learning model using these and similar annotated video footage and/or static images, the machine learning model may be trained to identify abnormal activity based on the identified normal activity and the identified anomalies. FIG. 28 illustrates an example of a static image used in risk scoring using the model of FIG. 18, according to some embodiments. As shown in FIG. 28, the still image depicts a large crowd gathered in an area, which may, if detected from a video input, indicate abnormal activity.

Referring now to FIGS. 29-30, an example of a user interface which can be used to receive a natural language search query and present video files/segments which are results of the natural language search query is shown, according to an exemplary embodiment. That is, the user interface shown in FIGS. 29-30 may be configured to facilitate the chatbot function, as described herein. In FIG. 29, the user interface is shown to include a text box which allows a user to enter a query. In the example shown in FIG. 29, the query is “a kid without adults near the escalator.” The user interface is shown to include a search button (e.g., “search in videos database”) which can be selected to search the database of video files. In response to initiating the search, the user interface may leverage a machine learning model to search the database of video files/segments and identify the most relevant videos/segments as search results (e.g., the chatbot response).

The machine learning model can be configured to parse the query to identify the relevant entities such as “kid,” “adults,” and “escalator.” The machine learning model may further use natural language processing to understand the relationships between the relevant entities. For example, the machine learning model may understand that “without adults” means that the “kid” is present, and the “adults” are not. The machine learning model may further understand that “near” implies a spatial proximity between the “kid” and the “escalator.” In some embodiments, the video files and segments may be ordered or ranked according to their relevancy scores and presented in the assigned order (e.g., with the most relevant video files/segments presented first). In some embodiments, the user interface indicates the rank assigned to each video file or segment (e.g., “Rank 1,” “Rank 2,” etc.) and/or the relevancy score assigned to each video file or segment (e.g., “score 0.31622,” “score 0.315,” etc.). In some embodiments, the user interface allows the video files and segments to be played directly from the user interface. For example, a user may click on or select a video file via the user interface to start playback of the video file. The user interface may allow the selected video file to be expanded (e.g., zooming in, full-screen view, etc.), as shown in FIG. 30. As can be seen from FIG. 30, the selected video file from the search results depicts a child standing near an escalator without adults.

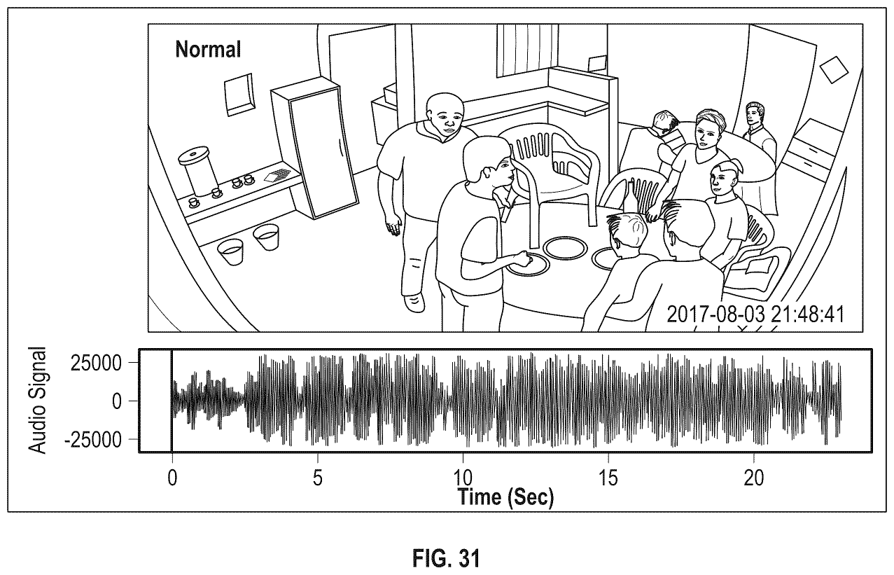

FIG. 31 illustrates an example of a static image from video data used to train the model of FIG. 18, according to some embodiments. As shown in FIG. 31, the static image has been annotated as normal. The static image depicts a first group of people standing around a table and a second group of people sitting at a table behind the first group of people. The persons, objects, activity, and other elements captured in the static image shown in FIG. 31 are not abnormal to the persons, objects, activity, and other elements expected to be captured. The video data may be accompanied by audio data received from the camera, the audio data including the audio signals across a duration of the video footage. In some embodiments, the audio data may be used to train the machine learning model to detect abnormal behavior. For example, as shown in FIG. 31, the static image annotated as normal corresponds to a beginning of the video footage, when the audio signals associated with the video data are at low levels.

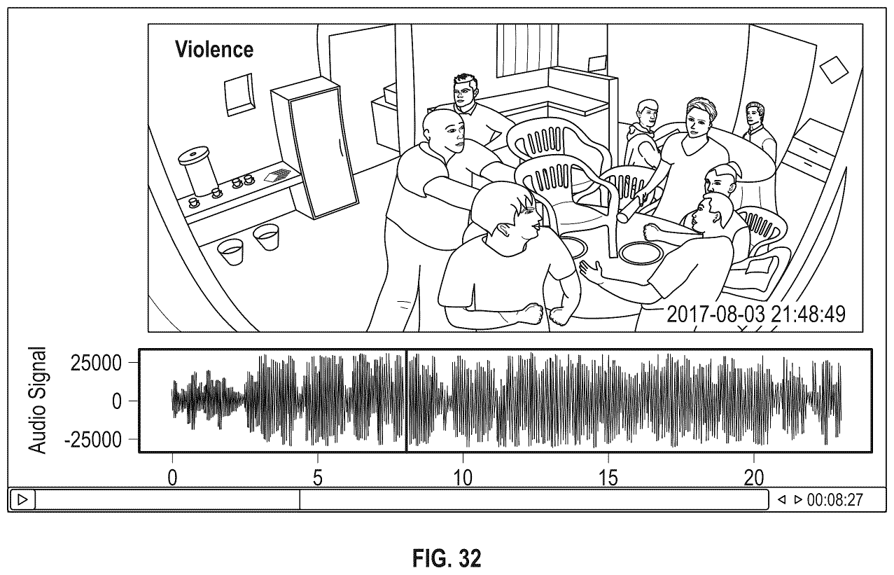

FIG. 32 illustrates another static image from the video data presented in FIG. 31, according to some embodiments. As shown in FIG. 32, the static image has been annotated as abnormal (e.g., “violence”). The static image depicts the first group of people fighting around the table. The persons, objects, activity, and other elements captured in the static image shown in FIG. 32 are not normal to the persons, objects, activity, and other elements expected to be captured. Furthermore, as shown in FIG. 32, the static image annotated as abnormal corresponds to a mid-point in the video footage, when the audio signals associated with the video data are at higher levels compared to audio signals associated with the still image depicted in FIG. 31.

One embodiment of the invention relates to building management systems and methods that implement building security operations. For example, a system can include at least one machine learning model configured using training data that includes at least one of unstructured data or structured data regarding security operations within the building. The system can provide inputs, such as prompts, to the at least one machine learning model regarding an abnormal situation, and generate, according to the inputs, actions in response the detected event, such as responses for evaluating the risk level of the situation, triggering automated actions to address the situation, or notifying security personnel of the situation. The machine learning model can include various machine learning model architectures (e.g., networks, backbones, algorithms, etc.), including but not limited to language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

At least one aspect relates to a system. The system can include one or more processors configured to receive training data. The training data can include at least one of a structured data or unstructured data regarding one or more security operations. The system can apply the training data as input to at least one neural network. Responsive to the input, the at least one neural network can generate a candidate output. The system can evaluate the candidate output relative to the training data, and update the at least one neural network responsive to the evaluation.

At least one aspect relates to a method. The method can include receiving, by one or more processors, training data. The training data can include at least one of a structured data or unstructured data regarding one or more security operations. The method can include applying, by the one or more processors, the training data as input to a neural network. The method can include generating, by the neural network responsive to the input, a candidate output. The method can include evaluating the candidate output relative to the training data. The method can include updating the at least one neural network responsive to the evaluation.

At least one aspect relates to a system. The system can include one or more processors configured to receive a prompt indicative of a security operation. The system can provide the prompt as input to a neural network. The neural network can be configured according to training data regarding example security operations, the training data comprising natural language data. The neural network can generate an output relating to the security operation responsive to processing the prompt using the transformer.

At least one aspect relates to a method. The method can include receiving, by one or more processors, a prompt indicative of a security operation. The method can include providing, by the one or more processors, the prompt as input to a neural network configured according to natural language data regarding example security operations. The method can include generating, by the one or more processors using the neural network, an output relating to the security operation responsive to processing the prompt.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A building security system comprising:
one or more computer-readable storage media having instructions stored thereon that, when executed by one or more processors, cause the one or more processors to:
provide one or more machine learning models, at least one of the one or more machine learning models trained to identify abnormalities within video data, the at least one machine learning model trained using at least one of video data or image data and annotations to the at least one of the video data or image data; and
provide a virtual agent configured to:
receive one or more input videos and process the one or more input videos using the at least one machine learning model to identify one or more abnormalities based on contextual information identified from the one or more input videos; and
automatically perform, by the one or more machine learning models, an operator function in response to the one or more abnormalities identified by the at least one machine learning model, wherein the operator function is determined according to at least one of a set of rules defined by the building security system or an operator input.

2. The building security system of claim 1, wherein the operator function comprises generating an incident report.

3. The building security system of claim 1, wherein the operator function comprises retrieving video footage from the one or more input videos.

4. The building security system of claim 1, wherein the operator function comprises performing a risk analysis.

5. The building security system of claim 1, wherein the operator function comprises dispatching first responder support.

6. The building security system of claim 1, wherein the operator function comprises activating one or more alarms.

7. The building security system of claim 1, wherein the image data further comprises a series of static images.

8. The building security system of claim 1, wherein the one or more machine learning models is a generative artificial intelligence (AI) model.

9. The building security system of claim 1, wherein the at least one machine learning model is trained by obtaining a foundation model and by tuning the foundation model using the annotations to the at least one of the video data or image data.

10. The building security system of claim 1, wherein the at least one machine learning model is trained using enterprise-specific training data relating to an enterprise within which the building security system is implemented.

11. The building security system of claim 10, wherein the enterprise-specific training data comprises at least one of annotations to at least one of video data or image data corresponding to the enterprise, a set of rules defined by the enterprise, a plurality of incident reports associated with the enterprise, or a plurality of crime reports associated with the enterprise.

12. A method comprising:
providing, by one or more processors, one or more machine learning models, at least one of the one or more machine learning models trained to identify abnormalities within video data, the at least one machine learning model trained using at least one of video data or image data and annotations to the at least one of the video data or image data; and
providing, by the one or more processors, a virtual agent configured to:
receive one or more input videos and process the one or more input videos using the at least one machine learning model to identify one or more abnormalities based on contextual information identified from the one or more input videos; and
automatically perform, by the one or more machine learning models, an operator function in response to the one or more abnormalities identified by the at least one machine learning model, wherein the operator function is determined according to at least one of a set of rules defined by a building security system or an operator input.

13. The method of claim 12, wherein the operator function comprises one or more of: generating an incident report, retrieving video footage from the one or more input videos, performing a risk analysis, or dispatching first responder support.

14. The method of claim 12, wherein the operator function comprises activating one or more alarms.

15. The method of claim 12, wherein the image data further comprises a series of static images.

16. The method of claim 12, wherein the one or more machine learning models is a generative artificial intelligence (AI) model.

17. The method of claim 12, wherein the at least one machine learning model is trained by obtaining a foundation model and by tuning the foundation model using the annotations to the at least one of the video data or image data.

18. The method of claim 12, wherein the at least one machine learning model is trained using enterprise-specific training data relating to an enterprise within which the building security system is implemented.

19. The building security system of claim 18, wherein the enterprise-specific training data comprises at least one of annotations to at least one of video data or image data corresponding to the enterprise, a set of rules defined by the enterprise, a plurality of incident reports associated with the enterprise, or a plurality of crime reports associated with the enterprise.

20. One or more non-transitory computer-readable media storing instructions thereon that, when executed by one or more processors, cause the one or more processors to perform operations comprising:
providing one or more machine learning models, at least one of the one or more machine learning models trained to identify abnormalities within video data, the at least one machine learning model trained using at least one of video data or image data and annotations to the at least one of the video data or image data; and
providing a virtual agent configured to:
receive one or more input videos and process the one or more input videos using the at least one machine learning model to identify one or more abnormalities based on contextual information identified from the one or more input videos; and
automatically perform, by the one or more machine learning models, an operator function in response to the one or more abnormalities identified by the at least one machine learning model, wherein the operator function is determined according to at least one of a set of rules defined by a building security system or an operator input.
